(19) United States
(12) Patent Application Publication
(10) Pub. No.: US 2026/0222158 A1
(43) Pub. Date: Jul. 30, 2026

(54) RECEIVER CONFIGURATION INDICATION IN CHANNEL STATE FEEDBACK

(71) Applicant: QUALCOMM Incorporated, San Diego, CA (US)

(72) Inventors: Weimin DUAN, San Diego, CA (US); Hyojin LEE, San Diego, CA (US); Gabi SARKIS, San Diego, CA (US); Jing JIANG, San Diego, CA (US); Hari SANKAR, San Diego, CA (US)

(21) Appl. No.: 19/038,917

(22) Filed: Jan. 28, 2025

(51) Int. Cl. H04L 5/00; H04B 7/06; H04W 24/10

(52) U.S. Cl. CPC H04L 5/0057; H04B 7/0626; H04W 24/10

(57) ABSTRACT

Certain aspects of the present disclosure provide techniques for communication of a receiver configuration in association with channel state feedback. An example method includes obtaining an indication to report channel state information (CSI); sending, after the indication to report the CSI, a first CSI report that includes an explicit indication of an association between the first CSI report and a first receiver configuration; and sending a second CSI report that includes an explicit indication of an association between the second CSI report and a second receiver configuration, wherein the first receiver configuration is different from the second receiver configuration.

### INTRODUCTION

Aspects of the present disclosure relate to wireless communications, and more particularly, to techniques for communication of receiver configuration in association with channel state feedback.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining an indication to report channel state information (CSI); sending, after the indication to report the CSI, a first CSI report that includes an explicit indication of an association between the first CSI report and a first receiver configuration; and sending a second CSI report that includes an explicit indication of an association between the second CSI report and a second receiver configuration, wherein the first receiver configuration is different from the second receiver configuration.

Certain aspects provide a method for wireless communications by a network entity. The method includes sending an indication to report CSI; obtaining, after the indication to report the CSI, a first CSI report that includes an explicit indication of an association between the first CSI report and a first receiver configuration; and obtaining a second CSI report that includes an explicit indication of an association between the second CSI report and a second receiver configuration, wherein the first receiver configuration is different from the second receiver configuration.

Certain aspects provide a method for wireless communications by a UE. The method includes obtaining first signaling that includes an indication to report a first aperiodic CSI report and an indication of an association between the first aperiodic CSI report and a first receiver configuration; sending the first aperiodic CSI report; obtaining second signaling that includes an indication to report a second aperiodic CSI report and an indication of an association between the second aperiodic CSI report and a second receiver configuration; and sending the second aperiodic CSI report.

Certain aspects provide a method for wireless communications by a network entity. The method includes sending first signaling that includes an indication to report a first aperiodic CSI report and an indication of an association between the first aperiodic CSI report and a first receiver configuration; obtaining the first aperiodic CSI report; sending second signaling that includes an indication to report a second aperiodic CSI report and an indication of an association between the second aperiodic CSI report and a second receiver configuration; and obtaining the second aperiodic CSI report.

Certain aspects provide an apparatus configured for wireless communications at a UE. The apparatus includes one or more memories and one or more processors coupled to the one or more memories. The one or more processors are configured to cause the UE to obtain an indication to report CSI; send, after the indication to report the CSI, a first CSI report that includes an explicit indication of an association between the first CSI report and a first receiver configuration; and send a second CSI report that includes an explicit indication of an association between the second CSI report and a second receiver configuration, wherein the first receiver configuration is different from the second receiver configuration.

Certain aspects provide an apparatus configured for wireless communications at a network node. The apparatus includes one or more memories and one or more processors coupled to the one or more memories. The one or more processors are configured to cause the network node to send an indication to report CSI; obtain, after the indication to report the CSI, a first CSI report that includes an explicit indication of an association between the first CSI report and a first receiver configuration; and obtain a second CSI report that includes an explicit indication of an association between the second CSI report and a second receiver configuration, wherein the first receiver configuration is different from the second receiver configuration.

Certain aspects provide an apparatus configured for wireless communications at a U. The apparatus includes one or more memories and one or more processors coupled to the one or more memories. The one or more processors are configured to cause the UE to obtain first signaling that includes an indication to report a first aperiodic CSI report and an indication of an association between the first aperiodic CSI report and a first receiver configuration; send the first aperiodic CSI report; obtain second signaling that includes an indication to report a second aperiodic CSI report and an indication of an association between the second aperiodic CSI report and a second receiver configuration; and send the second aperiodic CSI report.

Certain aspects provide an apparatus configured for wireless communications at a network node. The apparatus includes one or more memories and one or more processors coupled to the one or more memories. The one or more processors are configured to cause the network node to send first signaling that includes an indication to report a first aperiodic channel state information (CSI) report and an indication of an association between the first aperiodic CSI report and a first receiver configuration; obtain the first aperiodic CSI report; send second signaling that includes an indication to report a second aperiodic CSI report and an indication of an association between the second aperiodic CSI report and a second receiver configuration; and obtain the second aperiodic CSI report.

Certain aspects provide an apparatus configured for wireless communications at a user equipment (UE). The apparatus includes means for obtaining an indication to report CSI; means for sending, after the indication to report the CSI, a first CSI report that includes an explicit indication of an association between the first CSI report and a first receiver configuration; and means for sending a second CSI report that includes an explicit indication of an association between the second CSI report and a second receiver configuration, wherein the first receiver configuration is different from the second receiver configuration.

Certain aspects provide an apparatus configured for wireless communications at a network node. The apparatus means for sending an indication to report CSI; means for obtaining, after the indication to report the CSI, a first CSI report that includes an explicit indication of an association between the first CSI report and a first receiver configuration; and means for obtaining a second CSI report that includes an explicit indication of an association between the second CSI report and a second receiver configuration, wherein the first receiver configuration is different from the second receiver configuration.

Certain aspects provide an apparatus configured for wireless communications at a U. The apparatus means for obtaining first signaling that includes an indication to report a first aperiodic CSI report and an indication of an association between the first aperiodic CSI report and a first receiver configuration; means for sending the first aperiodic CSI report; means for obtaining second signaling that includes an indication to report a second aperiodic CSI report and an indication of an association between the second aperiodic CSI report and a second receiver configuration; and means for sending the second aperiodic CSI report.

Certain aspects provide an apparatus configured for wireless communications at a network node. The apparatus includes means for sending first signaling that includes an indication to report a first aperiodic CSI report and an indication of an association between the first aperiodic CSI report and a first receiver configuration; means for obtaining the first aperiodic CSI report; means for sending second signaling that includes an indication to report a second aperiodic CSI report and an indication of an association between the second aperiodic CSI report and a second receiver configuration; and means for obtaining the second aperiodic CSI report.

Certain aspects provide a non-transitory computer-readable medium. The non-transitory computer-readable medium comprises executable instructions that, when executed by one or more processors of one or more apparatuses, cause the one or more apparatuses to obtain an indication to report CSI; send, after the indication to report the CSI, a first CSI report that includes an explicit indication of an association between the first CSI report and a first receiver configuration; and send a second CSI report that includes an explicit indication of an association between the second CSI report and a second receiver configuration, wherein the first receiver configuration is different from the second receiver configuration.

Certain aspects provide a non-transitory computer-readable medium. The non-transitory computer-readable medium comprises executable instructions that, when executed by one or more processors of one or more apparatuses, cause the one or more apparatuses to send an indication to report CSI; obtain, after the indication to report the CSI, a first CSI report that includes an explicit indication of an association between the first CSI report and a first receiver configuration; and obtain a second CSI report that includes an explicit indication of an association between the second CSI report and a second receiver configuration, wherein the first receiver configuration is different from the second receiver configuration.

Certain aspects provide a non-transitory computer-readable medium. The non-transitory computer-readable medium comprises executable instructions that, when executed by one or more processors of one or more apparatuses, cause the one or more apparatuses to obtain first signaling that includes an indication to report a first aperiodic CSI report and an indication of an association between the first aperiodic CSI report and a first receiver configuration; send the first aperiodic CSI report; obtain second signaling that includes an indication to report a second aperiodic CSI report and an indication of an association between the second aperiodic CSI report and a second receiver configuration; and send the second aperiodic CSI report.

Certain aspects provide a non-transitory computer-readable medium. The non-transitory computer-readable medium comprises executable instructions that, when executed by one or more processors of one or more apparatuses, cause the one or more apparatuses to send first signaling that includes an indication to report a first aperiodic CSI report and an indication of an association between the first aperiodic CSI report and a first receiver configuration; obtain the first aperiodic CSI report; send second signaling that includes an indication to report a second aperiodic CSI report and an indication of an association between the second aperiodic CSI report and a second receiver configuration; and obtain the second aperiodic CSI report.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network node and a UE.

FIG. 6 depicts an example scheme of indicating a receiver configuration in association with channel state feedback.

FIG. 7 depicts an example scheme for aperiodic CSI reporting that includes an indication of the receiver configuration.

FIG. 8A depicts a process flow for signaling in association with a receiver configuration in channel state feedback

FIG. 8B depicts another process flow for signaling in association with a receiver configuration indication associated with channel state feedback.

FIG. 9 depicts a method for wireless communications.

FIG. 10 depicts another method for wireless communications.

FIG. 11 depicts another method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for communication of a receiver configuration in association with channel state feedback.

In certain wireless communications systems (e.g., 5G New Radio systems and/or any future wireless communications system), closed-loop feedback associated with a communication channel may be used to dynamically adapt communication parameters (e.g., modulation and coding scheme (MCS), beamforming, multiple-input and multiple-output (MIMO) layers, etc.) according to time varying channel conditions, for example, due to changes with respect to user equipment (UE) mobility, weather conditions, scattering, fading, interference, noise, etc. A UE may report channel state information to a network node (e.g., a base station or a disaggregated entity thereof as further described herein). The network node may adjust certain communication parameters in response to the CSI from the UE. For example, the network node may implement link adaptation (such as adaptive modulation and coding) with various modulation schemes and channel coding rates for communications between the UE and the network node.

As an example, a UE may measure a reference signal output at a network node, and the UE may estimate the channel state based on measurements of the reference signal. The UE may report CSI indicating an estimated channel state to the network node in the form of CSI report or CSI feedback. In certain aspects, the CSI may indicate channel properties of a communication link between the network node and the UE. For example, the CSI may indicate the effect of scattering, fading, and path loss of a signal propagating across the communication link. A CSI report or feedback may include a channel quality indicator (CQI), a precoding matrix indicator (PMI), a layer indicator (LI), a rank indicator (RI), a reference signal received power (RSRP), a signal-to-interference plus noise ratio (SINR), etc. Additional or other information may be included in a CSI report or feedback.

In certain cases, a UE may communicate with a network node via a bandwidth part (BWP) of a carrier. A BWP may be a contiguous frequency range (e.g., contiguous resource blocks) of a channel bandwidth of a carrier. The carrier may be a frequency range of one or more operating bands specified for wireless communications, such as an operating band of Frequency Range 1, Frequency Range 2, and/or any other suitable frequency ranges (for example, sub-terahertz frequency range(s)), as further described herein. A BWP may differ from a carrier in that a BWP occupies a subset of a carrier and in that the UE's active BWP can be dynamically switched between multiple configured BWPs (thus enabling adaptation of bandwidths, subcarrier spacings, and so on, without explicit reconfiguration of a carrier). A UE may not expect to receive or transmit certain communications, such as reference signaling, uplink channels, or downlink channels, outside an active BWP of the UE. In certain cases, a UE may be configured with a maximum number of MIMO layers that can be used for a downlink channel (e.g., a physical downlink shared channel (PDSCH)) in the BWP.

As a UE may be configured with a maximum number of MIMO layers for a PDSCH of a BWP, the UE may be expected to employ a receiver configuration (e.g., a certain number of receive chains and/or antennas), while monitoring reference signals for channel state feedback, that can be used to receive downlink transmissions at the maximum number of MIMO layers configured for the PDSCH. For example, the network node may adapt communications between the UE and the network node under the assumption that the channel state feedback is representative of a UE receiver configuration that can support the maximum number of MIMO layers configured for the PDSCH. However, using a receiver configuration that can support the maximum number of MIMO layers may use a non-trivial amount of power to monitor downlink reference signals at the UE, for example, due to the power consumption depending on the number of receive chains and/or antennas used to monitor the reference signals. Thus, the maximum number of MIMO layers configured for a PDSCH of a BWP may affect the power consumption at a UE to monitor reference signals for channel state feedback.

As another option, the network node may reconfigure the PDSCH to have a different maximum number of MIMO layers, or may switch downlink communications to another BWP with a different maximum number of MIIMO layers. However, reconfiguring a BWP to have a different maximum number of MIMO layers or switching between BWPs with different configured maximum numbers of MIMO layers may involve a non-trivial amount of time to ensure that channel state feedback is consistent with the maximum number of MIMO layers configured for a BWP. Thus, BWP reconfiguration and/or BWP switching may affect the latency of communications between a UE and a network node.

Aspects described herein provide certain schemes for indicating a receiver configuration associated with the channel state feedback, which may enable reduced power consumption, reduced latencies, improved reliability, and/or the like. As an example, when the UE uses a particular receiver configuration (e.g., two receive chains and/or antennas) to receive downlink reference signals for channel state feedback, the UE may include, in the CSI report, an explicit indication that the CSI report is associated with the receiver configuration. The explicit indication of the association (hereinafter “the association indication”) may indicate that the receiver configuration is used to derive at least a portion of the CSI report. CSI reports that include the same association indication may indicate that a group of CSI reports are derived from the same receiver configuration. The association indication may be or include a group or set identifier or identity associated with a specific receiver configuration or a combination of receiver configurations (e.g., a CSI group identifier (ID)). Thus, the association indication may effectively be a CSI group identifier or identity in association with the receiver configuration or hardware configuration applied at the UE for channel state feedback or the like.

Then, when the UE uses another receiver configuration (e.g., four receive chains and/or four antennas) to receive reference signals for channel state feedback, the UE may include, in another CSI report, a different explicit indication that the CSI report is associated with the other receiver configuration. The association indication may be or include, for example, an index value among a set of index values associated with a plurality of receiver configurations supported at the UE. Thus, the association indication may indicate that a separate receiver configuration among multiple supported receiver configurations is used to derive channel state information at a UE without indicating a specific receiver configuration, such as two receive chains (or antennas) versus four receive chains (or antennas).

Certain techniques for communication of the receiver configuration in channel state feedback described herein may provide various improvements and/or enhancements to wireless communications performance. The techniques for communication of the receiver configuration in channel state feedback may enable improved wireless communications performance, such as reduced power consumption, reduced latencies, reliable channel state information, and/or the like. The reduced power consumption may be attributable to the channel state feedback allowing the UE to switch among receiver configurations regardless of a maximum number of MIMO layers being configured for a BWP (and/or other communication parameters). As discussed, one receiver configuration may use less power at the UE to receive signaling than another receiver configuration. For example, the power consumption used to operate one or two receive chains and/or antennas may be less than the power consumption used to operate four, six, or eight receive chains and/or antennas. Thus, the association indication discussed above may allow the UE to notify a network node when the UE has switched receiver configurations, for example, in order to conserve power consumption.

In certain cases, the reduced latencies may be attributable to the UE being able to send channel state feedback, which indicates the receiver configuration used to derive the CSI, without relying on a BWP switch and/or BWP reconfiguration to specify the expected receiver configuration. For example, the UE may switch among receiver configurations that support the maximum number of MIMO layers or fewer MIMO layers without a BWP switch and/or BWP reconfiguration that specifies the expected MIMO layers.

In certain cases, the reliability of the channel state information may be attributable to the indication of the receiver configuration used to derive the CSI. Such an indication may enable the network node to take into account the different receiver configurations used at a UE when configuring the communications between the UE and the network node. The association indication may enable the network node to infer the receiver adaptation activity performed at the UE. The association indication may allow the network node to understand the reliability and/or quality of the CSI report. As an example, the UE may include the association indication in a CSI report, the network node may be able to determine whether the CSI report can be relied upon to communicate with the UE via the maximum number of MIMO layers or fewer MIMO layers. In certain cases, the association indication may enable the network node to adjust certain parameters for communications via the PDSCH (such as MCS, rank, and/or the like) and/or via the physical downlink control channel (PDCCH) (such as control resource set symbol duration, aggregation level, and/or the like). Thus, the communication of the receiver configuration in channel state feedback may enable reliable channel state information, in terms of indicating the channel conditions between the UE and the network node.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

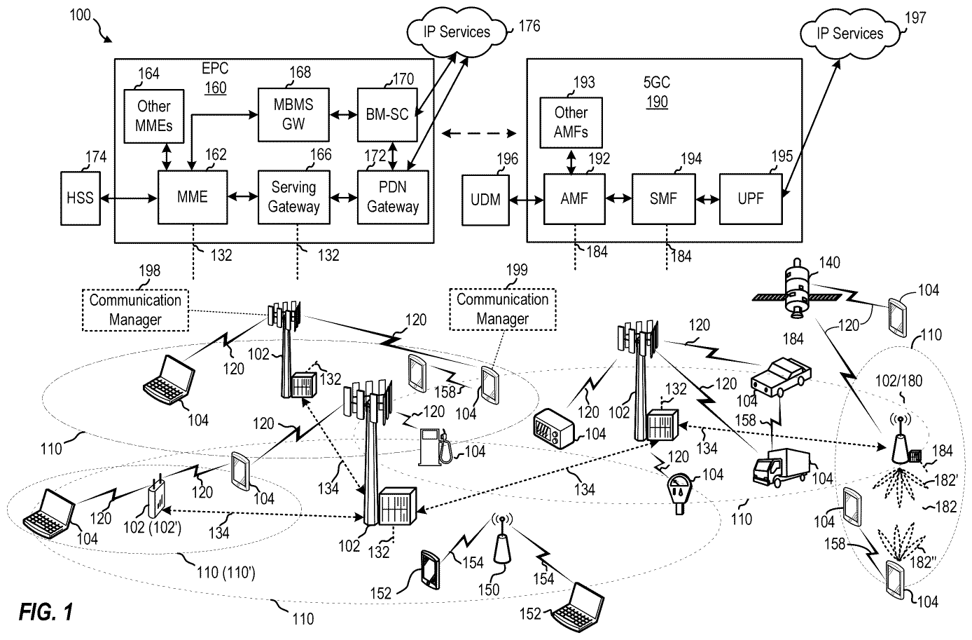

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

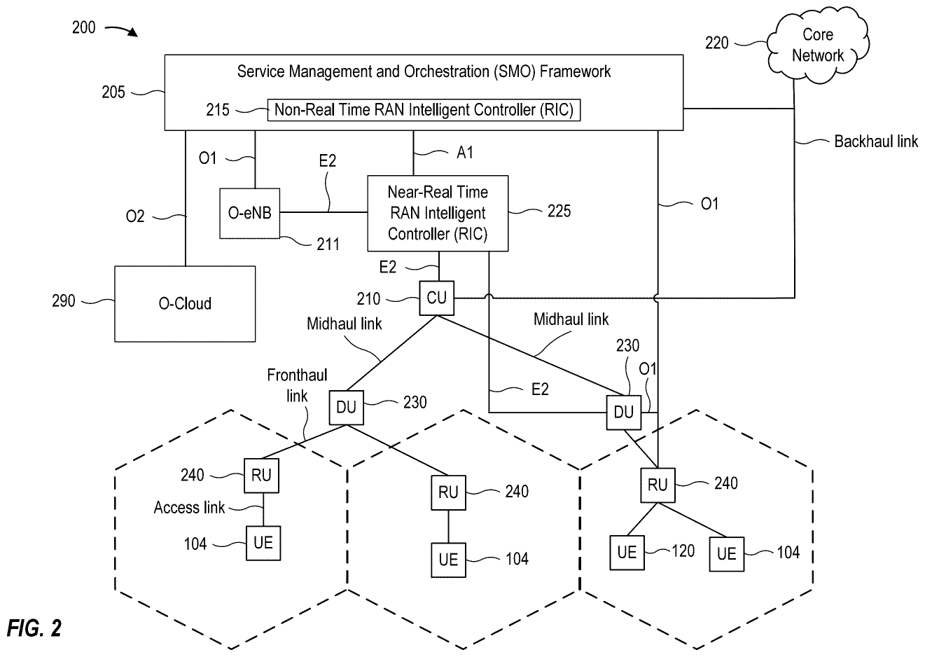

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

As shown, the BS 102 includes a communication manager 198. In certain aspects, the communication manager 198 may comprise and/or be referred to as an apparatus. The communication manager 198 may cause the BS 102 to perform actions relating to indicating a receiver configuration associated with the channel state feedback, as described elsewhere herein. As shown, the UE 104 includes a communication manager 199. The communication manager 199 may comprise and/or be referred to as an apparatus. The communication manager 199 may cause the UE 104 to perform actions relating to indicating a receiver configuration associated with the channel state feedback, as described elsewhere herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

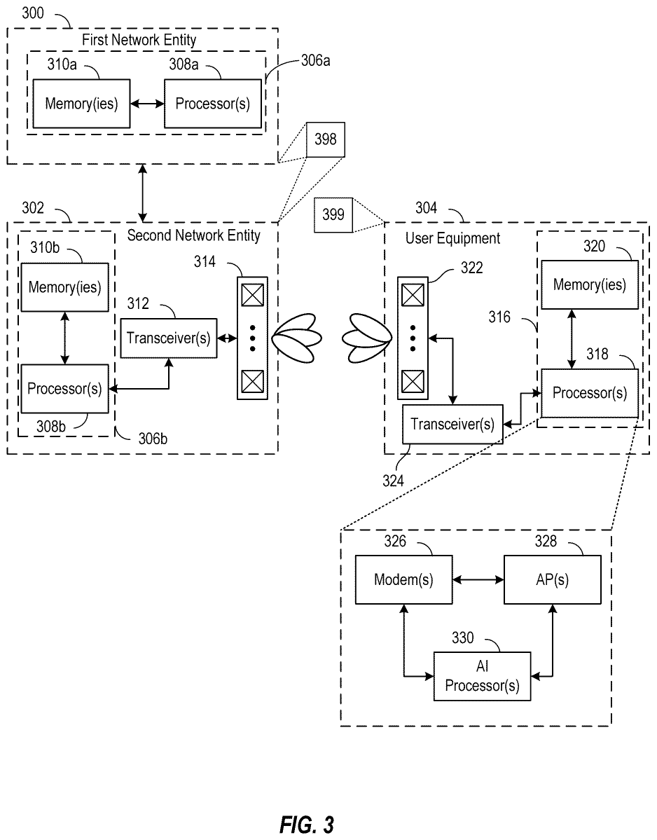

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

As shown, the UE 304 includes a communication manager 399, and the first network entity 300 and/or the second network entity 302 include a communication manager 398. The communication manager 398 may include or be implemented using one or more components of FIG. 3, such as the processing system 306, the one or more processors 308, the one or more memories 310, and/or the one or more transceivers 312. The communication manager 399 may include or be implemented using one or more components of FIG. 3, such as the processing system 316, the one or more processors 318, the one or more memories 320, and/or the one or more transceivers 324. The communication manager 398, 399 may be an example of the communication manager 198, 199, respectively. The communication manager 398, 399 may cause the UE 304 and/or the network entities 300, 302 to perform actions relating to indicating a receiver configuration associated with the channel state feedback, as described elsewhere herein.

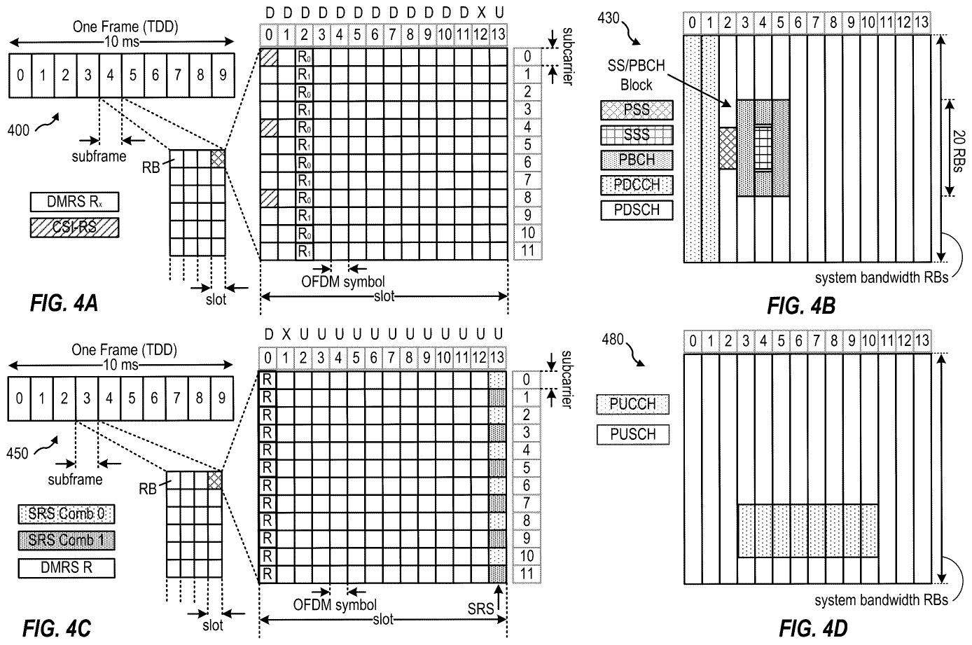

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Channel State Feedback

In certain wireless communication systems, closed-loop feedback associated with a communication channel between a UE and a network node may be used to dynamically adapt communication parameters to channel conditions that may change over time. In certain cases, a UE may transmit a reference signal (e.g., DMRS, SRS, etc.), and a network node (or another UE) may determine characteristics associated with the channel based on measurements of the received reference signal. In some cases, a UE may receive a reference signal (e.g., SSB, CSI-RS, DMRS, PT-RS, etc.) from a network node (or another UE) and report channel state feedback to the network node (or the other UE), where the channel state feedback is determined based on measurements of the reference signal received at the UE.

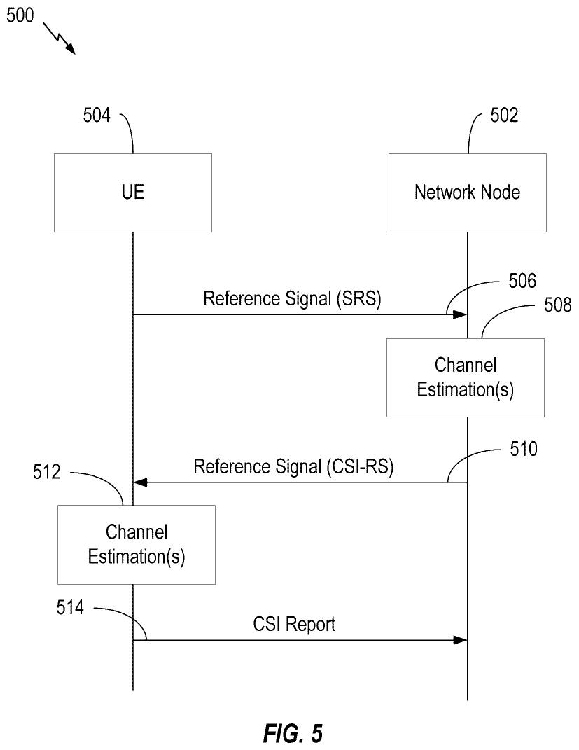

FIG. 5 depicts a process flow 500 for closed-loop feedback associated with a communication channel between a network node 502 and a UE 504.

At 506, UE 504 sends a reference signal (e.g., SSB, CSI-RS, DMRS, PT-RS, SRS, etc.) to the network node 502. In certain aspects, the UE 504 may send the reference signal (e.g. SRS) using one or more receive antenna ports, which may correspond to an SRS port or SRS antenna port. Transmission of the SRS via the receive antenna port may enable the network node 502 to deduce the downlink propagation channel associated with the receive antenna port based on channel reciprocity.

At 508, the network node 502 performs channel calculations based on the reference signal, such as determining a channel estimate H based on the received reference signal, for example, as further described herein with respect to the UE performing channel calculations at 512. In certain aspects, the network node 502 may further calculate, as part of the channel calculations, a precoder (e.g., precoder matrix) V based on the channel estimate H, for example, as further described herein with respect to the UE 504 performing such a calculation. Accordingly, the network node 502 may determine H and/or V for an uplink channel between UE 504 and network node 502 based on SRS. Further, the uplink channel between UE 504 and network node 502 may have reciprocity with a downlink channel between UE 504 and network node 502. Accordingly, the determined values of H and/or V for the uplink channel between UE 504 and network node 502 may be used for the downlink channel between UE 504 and network node 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network node 502 may apply a function to H and/or V determined for the uplink channel.

At 510, the UE 504 receives a reference signal (e.g., SSB, CSI-RS, etc.) from the network node 502. In certain aspects, the network node may send the reference signal with precoding (e.g., beamforming, MIMO layer(s), and/or compensation for signal propagation effects) based on the channel estimate and/or precoder determined at 508.

At 512, the UE 504 performs channel calculations based on the reference signal, such as determining a channel estimate H based on the received reference signal. For example, the UE 504 may include a demodulator or a baseband processor, which may be part of a modem (e.g., the one or more modems 326) of UE 504. The demodulator, such as a component of the modem, may obtain as input the reference signal as received over multiple antennas of the UE 504 and output (or determine) a vector \vec{y} that is a representation of the received reference signal as received over each of the multiple antennas of the UE 504.

Based on a received signal model, the vector \vec{y} can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network node 502 over a number of spatial layers, and n′ is noise across the communications channel. In certain aspects, H has a size equal to the number of antennas used to receive the signaling, Nₐₙₜ, times the number of spatial layers, Nₗ, (e.g., the number of beamformed transmissions, number of antenna ports, etc.). For example, H has a number of rows equal to Nₐₙₜ and a number of columns equal to Nₗ. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD (H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 514, UE 504 sends to the network node 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network node 502 in the CSI report. The network node 502 may schedule downlink data transmissions to the UE 504 accordingly, such as using a modulation scheme, code rate, number of MIMO layers, or the like, that the network node determines based on the CSI report.

### Aspects Related to Receiver Configuration Indication in Channel State Feedback

Aspects of the present disclosure provide certain schemes for indicating a receiver configuration associated with channel state feedback, which may enable reduced power consumption, reduced latencies, improved reliability, and/or the like.

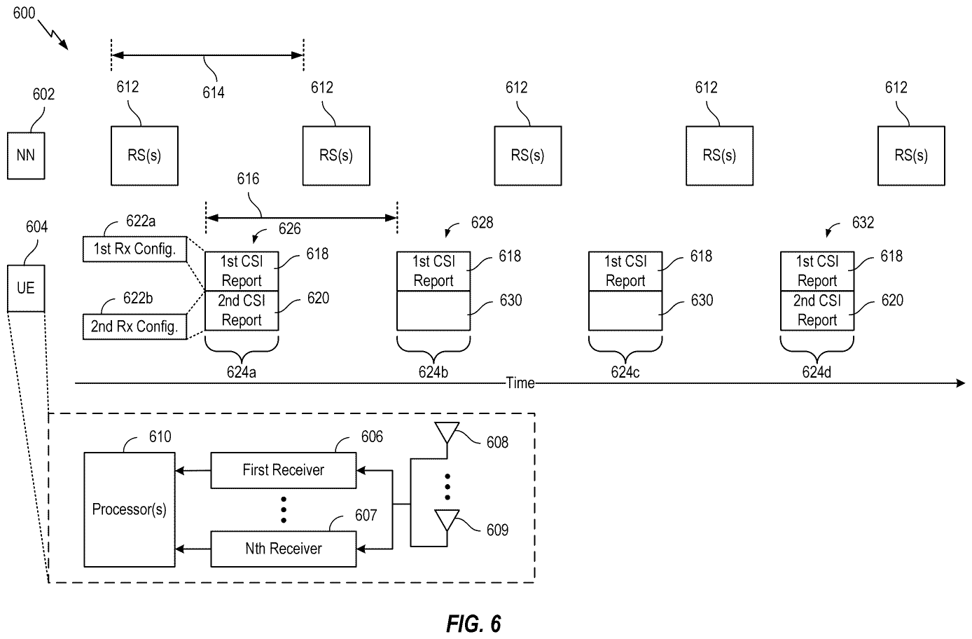

FIG. 6 depicts an example scheme 600 of indicating a receiver configuration in association with channel state feedback, such as one or more CSI reports. In this example, a UE 604 may be configured (e.g., via signaling, such as RRC signaling, MAC signaling, DCI, system information, and/or the like) to monitor and/or measure one or more reference signal transmissions from a network node 602 and report, to the network node 602, CSI associated with the reference signal(s), for example, as described herein with respect to FIG. 5. The reference signal(s) may include, for example, one or more SSBs, one or more CSI-RSs, one or more DMRSs, one or more PT-RSs, and/or the like. The UE 604 may be an example of the UE 104, 304, or 504 of FIGS. 1-3 and 5, respectively. The network node 602 may be an example of the BS 102 of FIG. 1, a disaggregated base station of FIG. 2, the first network entity 300 or the second network entity 302 of FIG. 3, and/or the network node 502 of FIG. 5.

The UE 604 may include a set of receivers including, for example, a first receiver 606 and/or an nth receiver 607 (where n of the nth receiver 607 may be an integer greater than or equal to 1). The set of receivers may be coupled between a set of antennas and one or more processors (hereinafter “the processor 610”). The set of antennas may include, for example, a first antenna 608 and/or an nth antenna 609 (where n of the nth antenna 609 may be an integer greater than or equal to 1). The set of antennas may be an example of the one or more antennas 322 of FIG. 3. The processor 610 may be an example of the one or more processors 318 of FIG. 3 and/or the processing system 316 of FIG. 3. Each of the first receiver 606 and the nth receiver 607 may be configured to feed signal(s) received, via at least one antenna of the set of antennas, to the processor 610. The first receiver 606 and/or the nth receiver 607 may be (or include) part of a transceiver (such as, the one or more transceivers 324 of FIG. 3). As an example, each of the first receiver 606 and the nth receiver 607 may be or include a receive chain (e.g., a receive path, a receiver path, or the like) of a transceiver, such as the one or more transceivers 324 of FIG. 3.

In certain aspects, the UE 604 may perform adaptive receive diversity (ARD). In certain cases, “ARD” may refer to certain techniques that adjust one or more parameters associated with signal reception in order to satisfy certain criteria, such as latency, throughput, reliability (e.g., a block error rate), power consumption, and/or the like. In certain cases, ARD may involve adjusting the total number of antennas used for signal reception and/or the specific set of antennas used for signaling reception. In certain cases, a specific ARD state (among multiple ARD states) may correspond to a receiver configuration. A receiver configuration may specify certain reception parameter(s) applied for (or in association with) signaling reception at or by a wireless communication device, such as the UE 604. A receiver configuration may correspond to a receiver hardware configuration implemented at the UE 604. As an example, the reception parameter(s) associated with a receiver configuration may include a specific receiver power mode, a total number of antennas, a specific set of antennas (e.g., a receive spatial diversity state), a total number of receivers, a specific set of receivers, receive beamforming (e.g., precoding weights and/or co-phasing weights), frequency tuning, a gain level or gain state, distortion compensation, automatic gain control, interference cancellation or compensation, and/or the like.

In certain aspects, receive antenna selection for wireless communications may be based on a received signal model, for example, as described herein with respect to FIG. 5 (such as y=HWx+n). In certain cases, the receive antenna(s) may be selected based on the mutual information (e.g., channel capacity or received signal quality) or received signal strength indicated by the received signal model. Antenna selection based on the mutual information may be expressed as follows:

$$\text{?} = arg {max}_{AS} \vert I + SNR \cdot {( {H}_{AS} W )}^{H} ( {H}_{AS} W ) \vert$$

Antenna selection based on received signal power may be expressed as follows:

$$\text{?} = arg {max}_{AS} tr ( {( {H}_{AS} W )}^{H} ( {H}_{AS} W ) )$$

As an example, the receive antenna(s) may be selected based on the receive antenna(s) that provide the highest channel capacity and/or highest received signal strength.

The UE 604 may receive signaling using a first receiver configuration, which may apply a first number of antennas of the set of antennas and/or a first number of receivers of the set of receivers (e.g., a 1 or 2 receive antenna mode). In certain cases, the UE 604 may receive signaling using a second receiver configuration, which may apply a second number antennas of the set of antennas and/or a second number of receivers of the set of receivers (e.g., a 4, 6, and/or 8 receive antenna mode). The first receiver configuration may use a different number of antennas and/or receivers than the second receiver configuration. As an example, the first receiver configuration may use fewer antennas and/or receivers than the second receiver configuration, and in some cases, may use a single antenna and/or a single receiver. As another example, the first receiver configuration may use two antennas of the set of antennas (and/or two receivers), and the second receiver configuration may use four antennas of the set of antennas (and/or four receivers). ARD may enable the UE 604 to switch between receiver configurations, for example, in order to satisfy certain criteria, such as such as latency, throughput, reliability (e.g., a block error rate), power consumption, and/or the like. As an example, the UE 604 may switch between receiver configurations to consume different levels of power and/or achieve different levels of throughput.

In certain cases, a particular receiver configuration may be part of another receiver configuration. A receiver configuration may include one or more other receiver configurations. For example, a two-antenna receiver configuration (e.g., the first receiver configuration) may be part of a four-antenna receiver configuration (e.g., the second receiver configuration). Signaling received via the four-antenna receiver configuration may include signaling received via a two-antenna receiver configuration. Accordingly, when the UE 604 obtains signaling via a receiver configuration (such as the second receiver configuration), the UE 604 may be capable of generating CSI associated with certain receiver configurations (such as the first receiver configuration), which may be part of or included in the receiver configuration (such as the second receiver configuration).

In certain cases, the UE 604 may be configured (e.g., via signaling, such as RRC signaling) to report the CSI with a periodicity, for example, associated with periodic and/or semi-persistent CSI reporting. As an example, the UE 604 may be configured with periodic CSI resource(s) in which one or more reference signals 612 may be communicated with a first periodicity 614. The network node 602 may send the reference signal(s) 612 in the periodic CSI resource(s), such as the time-frequency resource(s) described herein with respect to FIGS. 4A, 4B, 4C, and 4D. The UE 604 may be configured to send a periodic CSI report, which may indicate or include measurement(s) of the periodic CSI resource(s), with a second periodicity 616.

In certain cases, the UE 604 may be configured (e.g., via signaling, such as RRC signaling) to report the CSI in response to certain criteria being satisfied, such as in response to signaling associated with an aperiodic trigger state. As an example, the UE 604 may obtain, from the network node 602, a configuration that indicates an association between an aperiodic trigger state and one or more CSI reports. Then, the UE 604 may obtain, from the network node 602, DCI that indicates to report certain CSI associated with the configured aperiodic trigger state.

In a CSI report, the UE 604 may include an explicit indication of an association between the CSI report and a receiver configuration (such as the first receiver configuration or the second receiver configuration). The explicit indication of the association (hereinafter “the association indication”) may indicate that at least a portion of the CSI report is based at least in part on one or more measurements associated with the receiver configuration (for example, measurement(s) of signaling received or obtained via the receiver configuration or obtained via another receiver configuration that includes the receiver configuration). The association indication may indicate that the UE 604 used a separate receiver configuration among multiple receiver configurations to derive at least a portion of the CSI report. The association indication may indicate that at least a portion of the CSI report is derived from the receiver configuration. As an example, the UE 604 may send a first CSI report 618 that includes an explicit indication of an association between the first CSI report 618 and the first receiver configuration (e.g., the first association indication 622a corresponding to the first receiver configuration).

In certain aspects, the association indication may be or include a specific index value among a set of index values. Each of the index values may correspond to a specific, separate, or different receiver configuration or a combination of receiver configurations (such as the first receiver configuration, the second receiver configuration, and/or a combination of receiver configurations). As an example, the UE 604 may use a first index value (e.g., a value of ‘0’) to indicate the association for the first receiver configuration, and a second index value (e.g., a value of ‘1’) to indicate the association for the second receiver configuration.

In certain aspects, the association indication may be or include a group or set identifier or identity associated with a specific receiver configuration or a combination of receiver configurations (e.g., a CSI group identifier (ID)). As an example, the UE 604 may use a first CSI group ID (e.g., a value of ‘0’) to indicate the association for the first receiver configuration, and a second CSI group ID (e.g., a value of ‘1’) to indicate the association for the second receiver configuration.

In certain aspects, the CSI report may include a specific field dedicated to indicating the association indication. The field may be a bit flag for indicating a particular receiver configuration, for example, among two receiver configurations. In certain cases, the field may be a bit string associated with a set of index values. The set of index values may correspond to two or more receiver configurations.

In certain aspects, the association indication may be specific to the CSI report. The association indication may be commonly applied to the parameters or quantities included in the CSI report. For example, all of the parameters and/or quantities included in the CSI report may be associated with the same receiver configuration as indicated by the association indication. In certain aspects, the association indication may be specific to a subset of the parameters or quantities included in the CSI report. For example, certain parameter(s) of the CSI report may be associated with a receiver configuration, such as the CQI, RI, PMI, RSRP, SINR, and/or the like.

In certain cases, the association indication may or may not indicate specific detail(s) about the receiver configuration, such as a specific number of antennas and/or a specific number of receivers in the receiver configuration. If the association indication does not indicate specific detail(s) about the receiver configuration, this may provide, to certain manufacturers of wireless communication devices (such as UEs), flexibility in designing, implementing, and/or developing innovations for receiver configurations for or at a UE 604 without being tied to or expected to use specific receiver configurations.

In certain aspects, the UE 604 may be configured to report multiple CSI reports in a CSI report transmission. Each of the CSI reports may be associated with a different receiver configuration or a combination of receiver configurations. As an example, the UE 604 may send, in a first transmission occasion 624a, a report 626 that includes the first CSI report 618 and a second CSI report 620. The first CSI report 618 may include the first association indication corresponding to the first receiver configuration. The second CSI report 620 may include an explicit indication of an association between the second CSI report 620 and the second receiver configuration (e.g., the second association indication 622b corresponding to the second receiver configuration).

In certain aspects, the UE 604 may be allowed to select the receiver configuration(s) used for channel state feedback (for example, according to ARD). In some cases, the UE 604 may skip or refrain from reporting CSI associated with a receiver configuration, for example, due to the UE 604 determining to disable a specific receiver configuration. For example, when the UE 604 is in a low traffic scenario, low throughput scenario, low power scenario (e.g., a sleep mode, idle mode, and/or inactive mode), and/or the like, the UE 604 may switch from using the second receiver configuration to using the first receiver configuration to monitor and/or measure for reference signals and generate CSI for a CSI report. The UE 604 may obtain one or more reference signals using the first receiver configuration (for example, due to the UE 604 being in a low traffic scenario). For example, the UE 604 may obtain the reference signal(s) 612 via the set of antenna(s) and/or the set of receiver(s) associated with the first receiver configuration. The UE 604 may send, in a second transmission occasion 624b (and a third transmission occasion 624c), an instance of the periodic CSI report 628 that includes the first CSI report 618 without the second CSI report 620 (thereby skipping or refraining from transmission of the second CSI report 620). Thus, the UE 604 may reduce power consumption due to the first receiver configuration being used for measuring or monitoring the reference signal(s) 612. Accordingly, the association indication(s) may enable the UE 604 to reduce the power consumption used to operate receivers and/or antennas for reference signal monitoring or measurement.

In certain cases, the UE 604 may be configured with or allocated a set of communication resources (e.g., one or more PUSCH resources and/or one or more PUCCH resources) for communication of one or more CSI reports. As an example, the UE 604 may be allocated enough communication resources to send up to two CSI reports to the network node 602, such as the first CSI report 618 and the second CSI report 620. The UE 604 may be allocated a first set of communication resources for communication a CSI report (e.g., the first CSI report 618) and a second set of communication resources for communication of another CSI report (e.g., the second CSI report 620). When the UE 604 skips or refrains from reporting CSI associated with a specific receiver configuration, the UE 604 may use only a portion of the communication resources, for example, enough communication resources to send the first CSI report 618.

In certain aspects, when the UE 604 skips or refrains from reporting CSI associated with a specific receiver configuration, the UE 604 may notify the network node 602 that the CSI report is not being reported. For example, the UE 604 may send, to the network node 602, a specific signal or information (e.g., a dummy or known signaling sequence), via one or more uplink resources (e.g., one or more PUSCH and/or PUCCH resources) allocated for the skipped CSI report, that indicates the CSI report is not being transmitted or communicated. In certain cases, the UE 604 may send, to the network node 602, an instance of the periodic CSI report that includes the first CSI report 618 and certain information 630 that includes substitute information associated with the second CSI report 620. The information 630 may be or include a dummy or known signaling sequence that indicates the second CSI report 620 (or at least one of the CSI reports) is omitted from the periodic CSI report transmission.

As an example, when the traffic load increases or is expected to increase, the UE 604 may switch to receiving the reference signal(s) 612 using at least the second receiver configuration (which may include the first receiver configuration). For example, prior to a fourth transmission occasion 624d, the UE 604 may obtain the reference signal(s) 612 using the second receiver configuration, which may include the first receiver configuration. The UE 604 may obtain the reference signal(s) 612 via the set of antennas and/or the set of receivers associated with the second receiver configuration. The UE 604 may send, in the fourth transmission occasion 624d, a report 632 that includes the first CSI report 618 and the second CSI report 620, which may include respective association indications (such as the first association indication 622a and the second association indication 622b).

The association indication(s) described herein may enable reliable channel state feedback and/or communications between the UE 604 and network node 602. The association indication(s) described herein may prevent or reduce instances of the network node 602 and the UE 604 being misaligned in terms of the assumptions or expectations made in association with the receiver configuration used at the UE 604 for deriving channel state feedback. As an example, the association indication(s) may indicate whether it is valid that the channel state feedback is representative of a receiver configuration that can support the maximum number of MIMO layers configured for a BWP. Accordingly, the association indication(s) may avoid or prevent ambiguities between the UE 604 and network node 602 in association with the channel state feedback.

As an example, the association indication(s) may enable the network node 602 to take into account or consider the receiver configuration(s) used at the UE 604 when configuring and/or scheduling communications with the UE 604, such as downlink signaling and/or uplink signaling. Based on the association indication in the CSI report, the network node 602 may schedule the UE 604 to receive downlink transmissions with certain communication parameters, such as a specific rank, modulation and coding scheme (MCS), symbol duration or subcarrier spacing, aggregation level, and/or the like. The network node 602 may schedule the UE 604 to receive downlink transmissions with a first number of MIMO layers based on the first CSI report 618 due to the first receiver configuration being capable of supporting the first number of MIMO layers, and the network node 602 may schedule the UE 604 to receive downlink transmissions with a second number of MIMO layers based on the second CSI report 620 due to the second receiver configuration being capable of supporting the second number of MIMO layers. Note that the maximum number of MIMO layers configured for a BWP is merely an example, and aspects of the present disclosure may be applied to other characteristic(s) associated with a wireless communications channel.

Note that the scenario(s) described herein, which may trigger a receiver configuration switch or change, are examples. Aspects of the present disclosure may apply to any suitable scenarios or situations in which the UE 604 may switch receiver configurations for channel state feedback, such as a network triggered or requested switch.

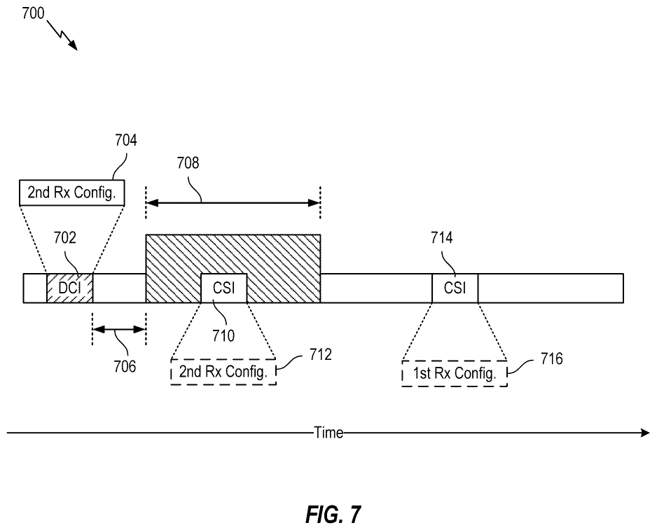

FIG. 7 depicts an example scheme 700 for aperiodic CSI reporting that includes an indication of the receiver configuration. In this example, a UE (e.g., the UE 604) may be configured (e.g., via RRC signaling) to report aperiodic CSI, for example, in response to certain signaling obtained from a network node (e.g., the network node 602). The network node may send, to the UE, DCI 702 that indicates to report aperiodic CSI associated with one or more CSI reports. The DCI 702 (e.g., DCI format 0_1 or the like) may include, for example, a CSI request field that indicates a specific aperiodic CSI trigger state associated with the CSI report(s). In certain aspects, the DCI 702, which triggers the UE to report aperiodic CSI, may indicate or request receiver configuration(s) for the UE to use to monitor and/or measure one or more reference signals in association with the aperiodic CSI report(s) triggered to be reported. As an example, the DCI 702 may include an explicit indication of one or more receiver configuration(s), for example, an association indication 704 corresponding to the second receiver configuration described herein with respect to FIG. 6.

In certain cases, the network node may configure (e.g., via RRC signaling) the UE with a mapping of receiver configurations to aperiodic CSI reports and/or aperiodic CSI trigger states. As an example, the UE may obtain one or more configurations that include an indication of an association between a first aperiodic CSI report and a first receiver configuration and an indication of an association between a second aperiodic CSI report and a second receiver configuration. The first receiver configuration of the UE may be associated with a first aperiodic CSI trigger state and/or a first CSI report, and the second receiver configuration of the UE may be associated with a second aperiodic CSI trigger state and/or a second CSI report. Accordingly, when the DCI 702 indicates to report a specific aperiodic CSI report, the requested aperiodic CSI report may further indicate a receiver configuration to use to derive the aperiodic CSI report.

In certain cases, the UE may determine the mapping of receiver configurations to aperiodic CSI reports and/or aperiodic CSI trigger states, in some cases, independent of the network node. As an example, the UE may determine the mapping of receiver configurations to aperiodic CSI reports and/or aperiodic CSI trigger states based on the signaling to be measured and/or the parameter(s) or quantities configured to be reported in a CSI report.

In certain cases, the DCI 702 may trigger or indicate for the UE to switch to a different receiver configuration, for example, after a first time period 706 of obtaining the DCI 702 at the UE. For example, prior to obtaining the DCI 702, the UE may be using the first receiver configuration to monitor or measure reference signal(s) from the network node. The DCI 702 may indicate to use a receiver configuration that is capable of supporting certain communication parameter(s), such as the maximum number of MIMO layers configured for a BWP. As an example, the DCI 702 may include an indication to switch receiver configurations and/or enable a receiver configuration that matches the network node's assumptions or expectations associated with the channel state feedback requested to be reported. The UE may select the receiver configuration based on the specified aperiodic CSI report. Accordingly, the DCI 702 may indicate for the UE to use a receiver configuration that is capable of supporting certain communications between the network node and the UE, such as the maximum number of MIMO layers configured for a BWP.

In certain aspects, the DCI 702 may indicate a specific receiver configuration to use to derive the aperiodic CSI report 710. As an example, the DCI 702 may indicate to obtain reference signal measurements using the second receiver configuration, for example, based on the mapping and/or an explicit indication of a receiver configuration.

As switching receiver configurations may take a non-trivial amount of time at the UE (for example, due to the time used to tune or switch a receiver and/or an antenna), the first time period 706 may have a duration that enables the UE to switch from a source (or current) receiver configuration to a target (or subsequent) receiver configuration, such as the second receiver configuration.

In certain cases, the UE may be configured to have the target receiver configuration enabled for a second time period 708 after the DCI 702. The second time period 708 may have a duration that at least enables the UE to obtain reference signal(s) associated with the triggered aperiodic CSI report. In this example, the UE may obtain the reference signals (not shown) using the target receiver configuration, and then, the UE may send the aperiodic CSI report 710 to the network node. In certain cases, the aperiodic CSI report 710 may include the association indication 712 corresponding to the second receiver configuration. The association indication 712 in the aperiodic CSI report 710 may indicate an acknowledgement of the target receiver configuration or confirmation that the target receiver configuration was used to derive the aperiodic CSI report 710.

In certain cases, for aperiodic CSI reporting, it may be assumed that the UE uses the specified or target receiver configuration associated with the aperiodic CSI report 710. Thus, the UE may not include the association indication 712 in the aperiodic CSI report 710. For example, the aperiodic CSI report 710 may include CSI without an explicit association indication.

The second time period 708 may include an inactivity time that accounts for any subsequent aperiodic CSI reporting associated with the target receiver configuration (e.g., the second receiver configuration). A portion of the second time period 708 may span in time after the transmission occasion allocated for the aperiodic CSI report 710. In certain cases, the UE may be triggered to report additional aperiodic CSI reporting (after transmission of the aperiodic CSI report 710), and thus, the second time period 708 may allow the UE to obtain the reference signals using the target receiver configuration, for example, without additional switching delays associated with receiver configurations. The second time period 708 may be configured as a timer that starts after the UE obtains the DCI 702, for example, after the first time period 706. In certain cases, the UE may start the timer corresponding to the second time period 708 upon obtaining signaling that indicates an aperiodic CSI report or an aperiodic CSI trigger state.

After the second time period 708, the UE may switch to the first receiver configuration, for example, in order to reduce power consumption. In certain cases, the UE may be configured (e.g., via signaling and/or a pre-configuration) to switch back to the first receiver configuration after the second time period 708. As an example, after the second time period 708, the UE may send, to the network node, another CSI report 714, which may include an explicit association indication 716 corresponding to the first receiver configuration.

Note that any of the aspects described herein with respect to aperiodic CSI reporting may be applied to periodic or semi-persistent CSI reporting, or vice versa.

### Example Signaling of Receiver Configuration Indication in Channel State Feedback

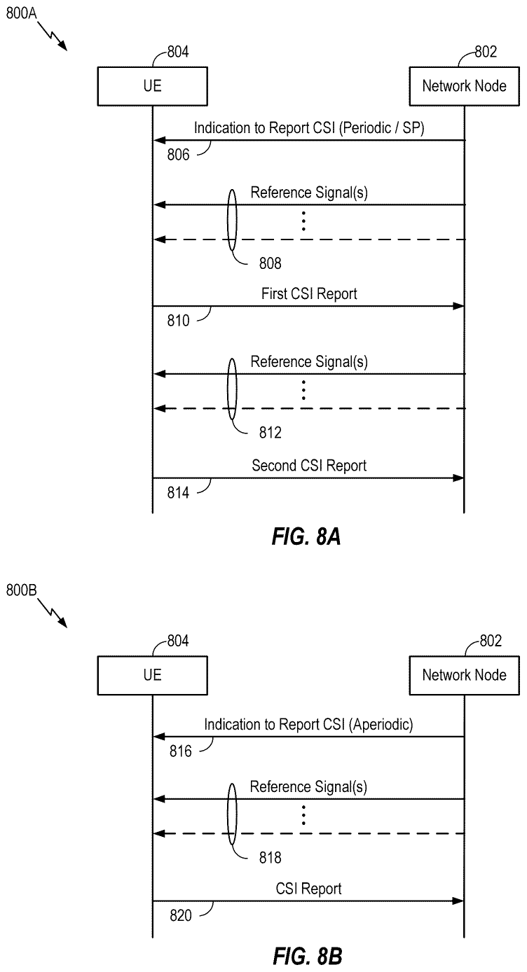

FIGS. 8A and 8B depict process flows 800A, 800B for signaling in association with a receiver configuration indication in channel state feedback in a system between a network node 802 and a UE 804. In some aspects, the network node 802 may be an example of the BS 102 depicted and described with respect to FIG. 1, the first network node 300 or the second network node 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device, and network node 802 may be another type of network entity or network node, such as those described herein. Note that any operations or signaling illustrated with dashed lines may indicate that that operation or signaling is an optional or alternative example.

With respect to FIG. 8A, at 806, the UE 804 obtains, from the network node 802, an indication to report CSI. As an example, the UE 804 may obtain one or more configurations may define periodic and/or semi-persistent CSI reporting, such as the periodic CSI resources and the periodic CSI report(s). As an example, the configuration(s) may indicate to report CSI with a periodicity, for example, as described herein with respect to FIG. 6. In certain cases, the configuration(s) may indicate one or more CSI resources to measure for CSI reporting. In certain cases, the configuration(s) may indicate the parameter(s) and/or quantities to include in one or more CSI reports and indicate the CSI resource(s) to measure in association with each of the CSI report(s). In certain cases, the configuration(s) may define aperiodic CSI reporting, such as the CSI resource(s) to measure for one or more aperiodic CSI reports and the aperiodic CSI trigger state associated with each of the aperiodic CSI report(s). In certain cases, the configuration(s) may indicate a mapping between one or more receiver configurations and CSI reports. The mapping may enable the network node 802 to request, based on a CSI report and/or aperiodic CSI trigger state, that the UE 804 report CSI associated with one or more receiver configurations, for example, as described herein with respect to FIGS. 6 and 7. Thus, the DCI may indicate to report the aperiodic CSI based on one or more receiver configurations. The indication to report CSI may be communicated via RRC signaling, MAC signaling, DCI, system information, and/or the like.

At 808, the UE 804 obtains, from the network node 802, first signaling that includes one or more reference signals, for example, including one or more SSBs, one or more CSI-RSs, one or more DMRSs, and/or the like. The reference signal(s) may be communicated in association with the indication to report CSI obtained at 806, for example, in the CSI communication resources specified in the configuration(s). The UE 804 may obtain the reference signal(s) using a first receiver configuration, for example, as described herein with respect to FIG. 6. In certain cases, the UE 804 may select and use the first receiver configuration independent of the network node 802. In certain cases, the UE 804 may use the first receiver configuration based on the mapping specified in the configuration(s). In certain cases, the reference signal(s) may be communicated with a periodicity, for example, as described herein with respect to FIG. 6.

At 810, the UE 804 sends, to the network node 802, a first CSI report that includes an explicit indication of an association between the first CSI report and the first receiver configuration, for example, as described herein with respect to FIG. 6. The first CSI report may be communicated in association with the indication to report CSI obtained at 806. As an example, the UE 804 may send the first CSI report as part of a periodic instance of CSI reporting indicated in the configuration(s). The first CSI report may be communicated via uplink communication resource(s), such as PUSCH and/or PUCCH communication resource(s).

At 812, the UE 804 obtains, from the network node 802, second signaling that includes one or more reference signals, for example, as described with respect to 808. The UE 804 may obtain the reference signal(s) using a second receiver configuration, for example, as described herein with respect to FIG. 6. The first receiver configuration may be different from the second receiver configuration.

At 814, the UE 804 sends, to the network node 802, a second CSI report that includes an explicit indication of an association between the second CSI report and the second receiver, for example, as described herein with respect to FIG. 6. The second CSI report may be communicated via uplink communication resource(s), such as PUSCH and/or PUCCH communication resource(s).

With respect to FIG. 8B, at 816, the UE 804 obtains, from the network node 802, an indication to report CSI. As an example, the UE 804 may obtain signaling (e.g., DCI) that indicates to report an aperiodic CSI report associated with one or more receiver configurations, for example, as described herein with respect to FIG. 7. In certain cases, the signaling may include an explicit indication of the association between the CSI report and the requested receiver configuration(s). The signaling may indicate to report the aperiodic CSI report based on the second receiver configuration, which may mean for the UE 804 to use the second receiver configuration to derive at least a portion of the aperiodic CSI report.

In certain cases, an indicated aperiodic CSI trigger state and/or CSI report may indicate the requested receiver configuration(s) based on a mapping specified in the configuration(s) described herein with respect to FIG. 8A.

At 818, the UE 804 obtains, from the network node 802, signaling that includes one or more reference signals, for example, including one or more SSBs, one or more CSI-RSs, one or more DMRSs, and/or the like. The UE 804 may obtain the reference signal(s) using the requested receiver configuration, for example, as described herein with respect to FIG. 7. In certain cases, the UE 804 may perform a receiver configuration switch according to the timeline as described herein with respect to FIG. 7.

At 820, the UE 804 sends, to the network node 802, a CSI report in association with the indication to report CSI. In certain cases, the CSI report may be communicated without an explicit association indication corresponding to the requested receiver configuration, and the network node 802 may assume that the CSI report is derived based on the requested receiver configuration. In certain cases, the CSI report may include an explicit indication of the association between the CSI report and the requested receiver configuration(s). The explicit association indication may confirm that CSI report is derived based on the requested receiver configuration. In certain cases, the CSI report may include an explicit indication of the association between the CSI report and another receiver configuration different from the requested receiver configuration.

As discussed herein, the association indication(s) of the receiver configuration in channel state feedback may allow the UE 804 to switch to receiver configuration(s) that enable power savings. In certain cases, the association indication(s) may allow the network node 802 to take into account or consider the receiver configuration (e.g., the first receiver configuration and/or the second receiver configuration) used at the UE 804 to derive at least a portion of a CSI report (such as the first CSI report at 810, the second CSI report at 814, and/or the CSI report at 820. Accordingly, the association indication(s) may enable reliable channel state feedback and/or communications between the UE 804 and network node 802.

Note that the process flow illustrated in FIG. 8 is described herein to facilitate an understanding of a an indication of receiver configuration in channels state feedback, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of Receiver Configuration Indication in Channel State Feedback

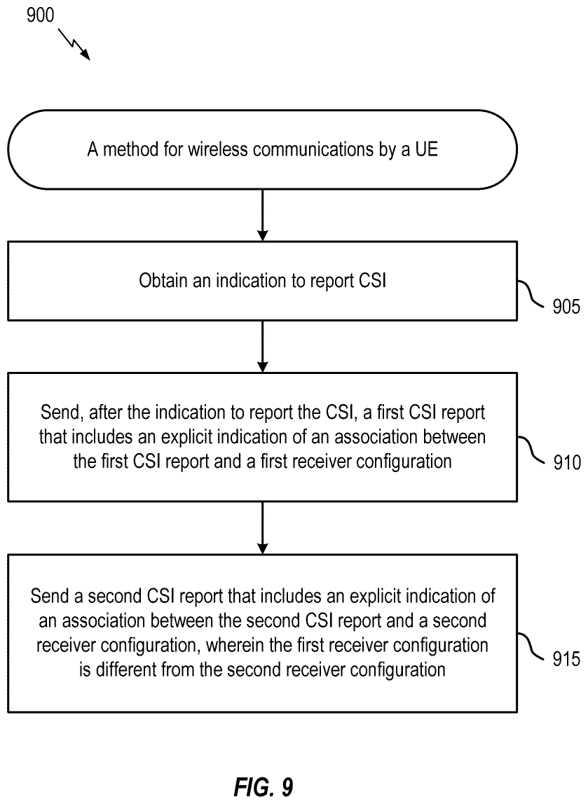

FIG. 9 shows a method 900 for wireless communications by a UE, such as UE 104 of FIG. 1 or UE 304 of FIG. 3.

Method 900 begins at block 905 with obtaining an indication to report CSI, for example, as described herein with respect to FIGS. 6-8B.

Method 900 then proceeds to block 910 with sending, after the indication to report the CSI, a first CSI report that includes an explicit indication of an association between the first CSI report and a first receiver configuration, for example, as described herein with respect to FIGS. 6-8B.

Method 900 then proceeds to block 915 with sending a second CSI report that includes an explicit indication of an association between the second CSI report and a second receiver configuration, wherein the first receiver configuration is different from the second receiver configuration, for example, as described herein with respect to FIGS. 6-8B.

In certain aspects, the association between the first CSI report and the first receiver configuration indicates at least a portion of the first CSI report is based at least in part on one or more measurements of the first receiver configuration. For example, the first CSI report may include one or more parameters or one or more quantities derived from the measurement(s) obtained via the first receiver configuration.

In certain aspects, method 900 further includes obtaining first signaling using the first receiver configuration, wherein the first CSI report includes an indication of one or more first measurements of the first signaling.

In certain aspects, method 900 further includes obtaining second signaling using the second receiver configuration, wherein the second CSI report includes an indication of one or more second measurements of the second signaling.

In certain aspects, the first receiver configuration includes a different number of receiver chains than the second receiver configuration.

In certain aspects, block 905 includes obtaining one or more configurations that indicate to report the CSI with a periodicity; and block 910 includes sending the first CSI report according to the one or more configurations.

In certain aspects, method 900 further includes sending a third CSI report according to the one or more configurations, wherein the third CSI report includes an explicit indication of an association between the third CSI report and the first receiver configuration.

In certain aspects, sending the first CSI report and the second CSI report comprises sending a third CSI report according to the one or more configurations, where the third CSI report includes the first CSI report and the second CSI report.

In certain aspects, the one or more configurations indicate to report CSI via a periodic report that includes the first CSI report and the second CSI report; block 910 includes sending, in a first transmission occasion, a first instance of the periodic report that includes the first CSI report without the second CSI report; and block 915 includes sending, in a second transmission occasion, a second instance of the periodic report that includes the first CSI report and the second CSI report.

In certain aspects, block 910 includes sending, in the first transmission occasion, the first instance of the periodic report that includes the first CSI report and information, wherein the information includes substitute information associated with the second CSI report.

In certain aspects, method 900 further includes sending an indication that the first CSI report is communicated via a first set of communication resources, and that the second CSI report is communicated via a second set of communication resources.

In certain aspects, the one or more configurations indicate the first CSI report is communicated via a first set of communication resources, and that the second CSI report is communicated via a second set of communication resources.

In certain aspects, block 905 includes obtaining signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period; block 910 includes sending the first CSI report after the signaling; and block 910 includes sending the second CSI report after the time period.

In certain aspects, the signaling further indicates to report the aperiodic CSI based on the first receiver configuration.

In certain aspects, method 900 further includes obtaining one or more configurations that indicates a first association between a first aperiodic CSI report and the first receiver configuration, and that indicates a second association between a second aperiodic CSI report and the second receiver configuration, wherein block 905 includes obtaining signaling that indicates to report the first aperiodic CSI report, and wherein block 910 includes sending the first CSI report after the signaling.

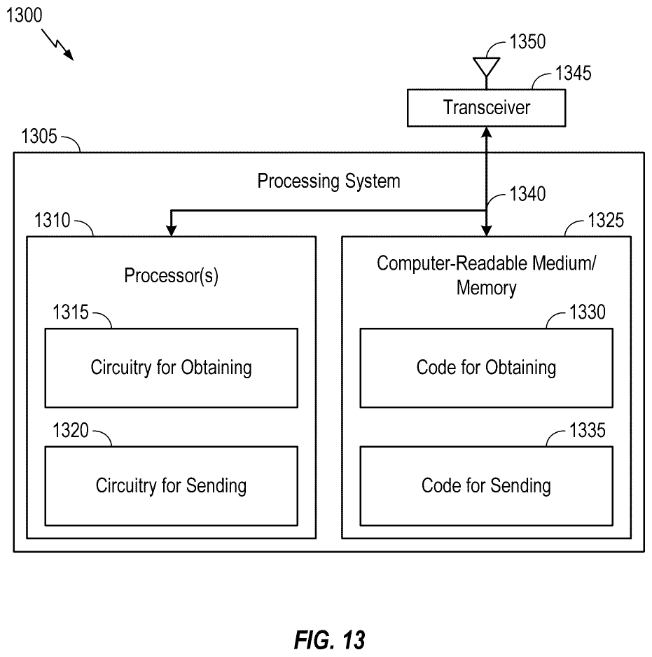

In certain aspects, method 900, or any aspect related to it, may be performed by an apparatus, such as communications device 1300 of FIG. 13, which includes various components operable, configured, or adapted to perform the method 900. Communications device 1300 is described below in further detail.

Note that FIG. 9 is just one example of a method, and other methods including fewer, additional, or alternative operations are possible consistent with this disclosure.

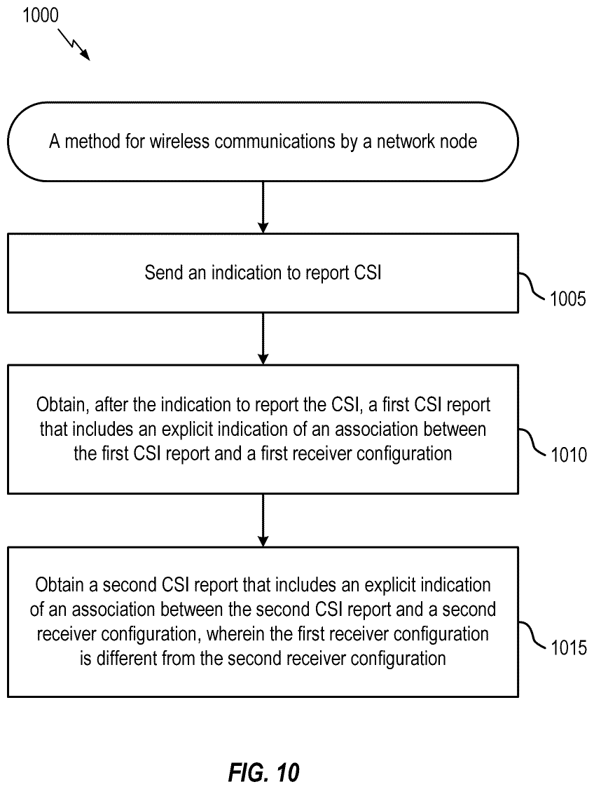

FIG. 10 shows a method 1000 for wireless communications by a network node, such as BS 102 of FIG. 1, a first network entity 300 or second network entity 302 of FIG. 3, or a disaggregated base station as discussed with respect to FIG. 2.

Method 1000 begins at block 1005 with sending an indication to report CSI, for example, as described herein with respect to FIGS. 6-8B.

Method 1000 then proceeds to block 1010 with obtaining, after the indication to report the CSI, a first CSI report that includes an explicit indication of an association between the first CSI report and a first receiver configuration for example, as described herein with respect to FIGS. 6-8B.

Method 1000 then proceeds to block 1015 with obtaining a second CSI report that includes an explicit indication of an association between the second CSI report and a second receiver configuration, wherein the first receiver configuration is different from the second receiver configuration, for example, as described herein with respect to FIGS. 6-8B.

In certain aspects, the association between the first CSI report and the first receiver configuration indicates at least a portion of the first CSI report is based at least in part on one or more measurements of the first receiver configuration.

In certain aspects, method 1000 further includes sending first signaling, wherein the first CSI report includes an indication of one or more first measurements of the first signaling.

In certain aspects, method 1000 further includes sending second signaling, wherein the second CSI report includes an indication of one or more second measurements of the second signaling.

In certain aspects, the first receiver configuration includes a different number of receiver chains than the second receiver configuration.

In certain aspects, block 1005 includes sending one or more configurations that indicate to report the CSI with a periodicity; and block 1010 includes obtaining the first CSI report according to the one or more configurations.

In certain aspects, method 1000 further includes obtaining a third CSI report according to the one or more configurations, wherein the third CSI report includes an explicit indication of an association between the third CSI report and the first receiver configuration.

In certain aspects, obtaining the first CSI report and the second CSI report comprises obtaining a third CSI report according to the one or more configurations, where the third CSI report includes the first CSI report and the second CSI report.

In certain aspects, the one or more configurations indicate to report CSI via a periodic report that includes the first CSI report and the second CSI report; block 1010 includes obtaining, in a first transmission occasion, a first instance of the periodic report that includes the first CSI report without the second CSI report; and block 1015 includes obtaining, in a second transmission occasion, a second instance of the periodic report that includes the first CSI report and the second CSI report.

In certain aspects, block 1010 includes obtaining, in the first transmission occasion, the first instance of the periodic report that includes the first CSI report and information, wherein the information includes substitute information associated with the second CSI report.

In certain aspects, method 1000 further includes obtaining an indication that the first CSI report is communicated via a first set of communication resources, and that the second CSI report is communicated via a second set of communication resources.

In certain aspects, the one or more configurations indicate the first CSI report is communicated via a first set of communication resources, and that the second CSI report is communicated via a second set of communication resources.

In certain aspects, block 1005 includes sending signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period; block 1010 includes obtaining the first CSI report after the signaling; and block 1015 includes obtaining the second CSI report after the time period.

In certain aspects, the signaling further indicates to report the aperiodic CSI based on the first receiver configuration.

In certain aspects, method 1000 further includes sending one or more configurations that indicates a first association between a first aperiodic CSI report and the first receiver configuration, and that indicates a second association between a second aperiodic CSI report and the second receiver configuration, wherein block 1005 includes sending signaling that indicates to report the first aperiodic CSI report, wherein block 1010 includes obtaining the first CSI report after the signaling.

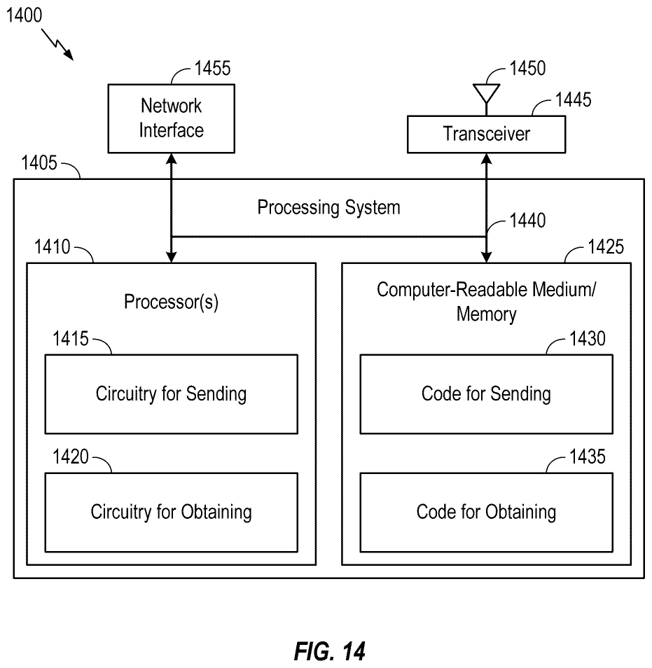

In certain aspects, method 1000, or any aspect related to it, may be performed by an apparatus, such as communications device 1400 of FIG. 14, which includes various components operable, configured, or adapted to perform the method 1000. Communications device 1400 is described below in further detail.

Note that FIG. 10 is just one example of a method, and other methods including fewer, additional, or alternative operations are possible consistent with this disclosure.

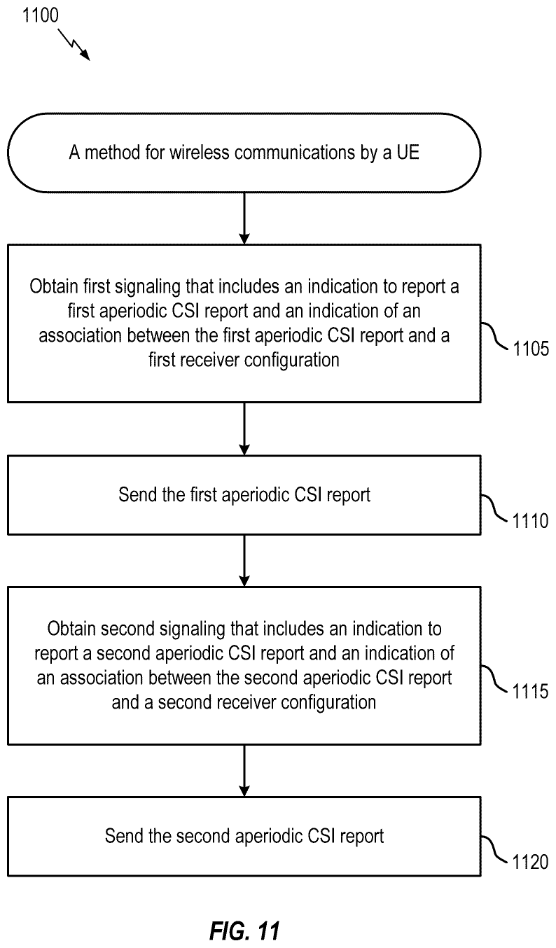

FIG. 11 shows a method 1100 for wireless communications by a UE, such as UE 104 of FIG. 1 or UE 304 of FIG. 3.

Method 1100 begins at block 1105 with obtaining first signaling that includes an indication to report a first aperiodic CSI report and an indication of an association between the first aperiodic CSI report and a first receiver configuration, for example, as described herein with respect to FIGS. 6-8B.

Method 1100 then proceeds to block 1110 with sending the first aperiodic CSI report, for example, as described herein with respect to FIGS. 6-8B.

Method 1100 then proceeds to block 1115 with obtaining second signaling that includes an indication to report a second aperiodic CSI report and an indication of an association between the second aperiodic CSI report and a second receiver configuration, for example, as described herein with respect to FIGS. 6-8B.

Method 1100 then proceeds to block 1120 with sending the second aperiodic CSI report, for example, as described herein with respect to FIGS. 6-8B.

In certain aspects, the association between the first aperiodic CSI report and the first receiver configuration indicates at least a portion of the first aperiodic CSI report is based at least in part on one or more measurements of the first receiver configuration.

In certain aspects, method 1100 further includes obtaining third signaling using the first receiver configuration, wherein the first aperiodic CSI report includes an indication of one or more first measurements of the third signaling.

In certain aspects, method 1100 further includes obtaining fourth signaling using the second receiver configuration, wherein the second aperiodic CSI report includes an indication of one or more second measurements of the fourth signaling.

In certain aspects, the first receiver configuration includes a different number of receiver chains than the second receiver configuration.

In certain aspects, the first signaling further includes an indication to enable the first receiver configuration for CSI measurement for a time period after the first signaling, and wherein the first signaling further includes an indication to enable the second receiver configuration for CSI measurement after the time period; block 1110 includes sending the first aperiodic CSI report after the first signaling; and block 1120 includes sending the second aperiodic CSI report after the time period.

In certain aspects, the first signaling further indicates to report the first aperiodic CSI report based on the first receiver configuration.

In certain aspects, method 1100 further includes obtaining one or more configurations that includes an explicit indication of an association between the first aperiodic CSI report and the first receiver configuration, and an explicit indication of an association between the second aperiodic CSI report and the second receiver configuration, wherein the indication of the association between the first aperiodic CSI report and the first receiver configuration includes an explicit indication of the association between the first aperiodic CSI report and the first receiver configuration, and wherein block 1110 includes sending the first aperiodic CSI report after the first signaling.

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

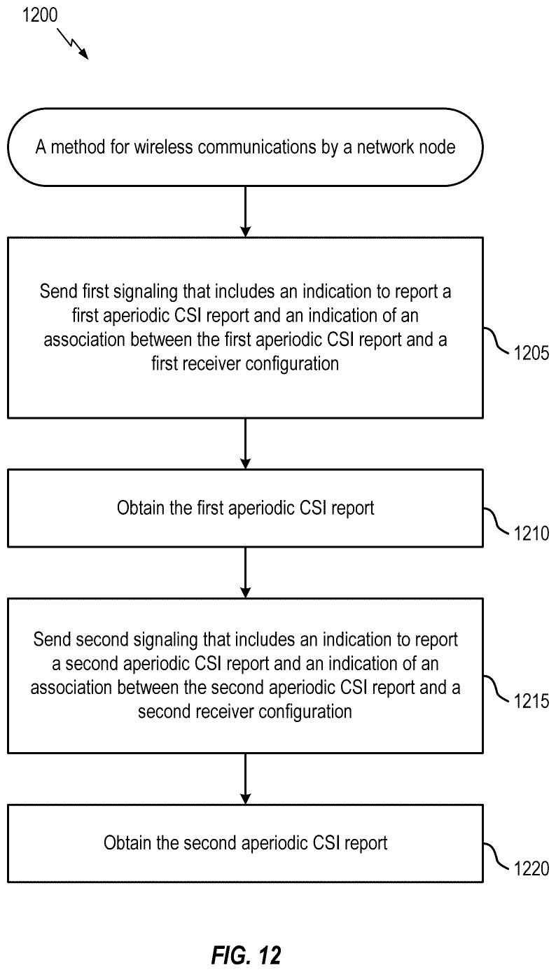

FIG. 12 shows a method 1200 for wireless communications by a network node, such as BS 102 of FIG. 1, a first network entity 300 or second network entity 302 of FIG. 3, or a disaggregated base station as discussed with respect to FIG. 2.

Method 1200 begins at block 1205 with sending first signaling that includes an indication to report a first aperiodic CSI report and an indication of an association between the first aperiodic CSI report and a first receiver configuration, for example, as described herein with respect to FIGS. 7 and 8B.

Method 1200 then proceeds to block 1210 with obtaining the first aperiodic CSI report, for example, as described herein with respect to FIGS. 7 and 8B.

Method 1200 then proceeds to block 1215 with sending second signaling that includes an indication to report a second aperiodic CSI report and an indication of an association between the second aperiodic CSI report and a second receiver configuration, for example, as described herein with respect to FIGS. 7 and 8B.

Method 1200 then proceeds to block 1220 with obtaining the second aperiodic CSI report, for example, as described herein with respect to FIGS. 7 and 8B.

In certain aspects, the association between the first aperiodic CSI report and the first receiver configuration indicates at least a portion of the first aperiodic CSI report is based at least in part on one or more measurements of the first receiver configuration.

In certain aspects, method 1200 further includes sending third signaling, wherein the first aperiodic CSI report includes an indication of one or more first measurements of the third signaling.

In certain aspects, method 1200 further includes sending fourth signaling, wherein the second aperiodic CSI report includes an indication of one or more second measurements of the fourth signaling.

In certain aspects, the first receiver configuration includes a different number of receiver chains than the second receiver configuration.

In certain aspects, the first signaling further includes an indication to enable the first receiver configuration for CSI measurement for a time period after the first signaling, and wherein the first signaling further includes an indication to enable the second receiver configuration for CSI measurement after the time period; block 1210 includes obtaining the first aperiodic CSI report after the first signaling; and block 1220 includes obtaining the second aperiodic CSI report after the time period.

In certain aspects, the first signaling further indicates to report the first aperiodic CSI report based on the first receiver configuration.

In certain aspects, method 1200 further includes sending one or more configurations that includes an explicit indication of an association between the first aperiodic CSI report and the first receiver configuration, and an explicit indication of an association between the second aperiodic CSI report and the second receiver configuration, wherein the indication of the association between the first aperiodic CSI report and the first receiver configuration includes an explicit indication of the association between the first aperiodic CSI report and the first receiver configuration, and block 1210 includes obtaining the first aperiodic CSI report after the first signaling.

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 900 described with respect to FIG. 9, or any aspect related to it, including any operations described in relation to FIG. 9; and the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330 and code for sending 1335. Processing of the code 1330 and 1335 may enable and cause the communications device 1300 to perform the method 900 described with respect to FIG. 9, or any aspect related to it; and the method 1100 described with respect to FIG. 11, or any aspect related to it.

For example, in some aspects, code for obtaining 1330 includes code for obtaining an indication to report CSI. In some aspects, code for sending 1335 includes code for sending, after the indication to report the CSI, a first CSI report that includes an explicit indication of an association between the first CSI report and a first receiver configuration. In some aspects, code for sending 1335 includes code for sending a second CSI report that includes an explicit indication of an association between the second CSI report and a second receiver configuration, wherein the first receiver configuration is different from the second receiver configuration.

For example, in some aspects, code for obtaining 1330 includes code for obtaining first signaling that includes an indication to report a first aperiodic CSI report and an indication of an association between the first aperiodic CSI report and a first receiver configuration. In some aspects, code for sending 1335 includes code for sending the first aperiodic CSI report. In some aspects, code for obtaining 1330 includes code for obtaining second signaling that includes an indication to report a second aperiodic CSI report and an indication of an association between the second aperiodic CSI report and a second receiver configuration. In some aspects, code for sending 1335 includes code for sending the second aperiodic CSI report.

The one or more processors 1310 include circuitry configured to implement (e.g., execute) the code stored in the computer-readable medium/memory 1325, including circuitry for obtaining 1315 and circuitry for sending 1320. Processing with circuitry 1315 and 1320 may enable and cause the communications device 1300 to perform the method 900 described with respect to FIG. 9, or any aspect related to it; and the method 1100 described with respect to FIG. 11, or any aspect related to it.

For example, in some aspects, circuitry for obtaining 1315 includes circuitry for obtaining an indication to report CSI. In some aspects, circuitry for sending 1320 includes circuitry for sending, after the indication to report the CSI, a first CSI report that includes an explicit indication of an association between the first CSI report and a first receiver configuration. In some aspects, circuitry for sending 1320 includes circuitry for sending a second CSI report that includes an explicit indication of an association between the second CSI report and a second receiver configuration, wherein the first receiver configuration is different from the second receiver configuration.

For example, in some aspects, circuitry for obtaining 1315 includes circuitry for obtaining first signaling that includes an indication to report a first aperiodic CSI report and an indication of an association between the first aperiodic CSI report and a first receiver configuration. In some aspects, circuitry for sending 1320 includes circuitry for sending the first aperiodic CSI report. In some aspects, circuitry for obtaining 1315 includes circuitry for obtaining second signaling that includes an indication to report a second aperiodic CSI report and an indication of an association between the second aperiodic CSI report and a second receiver configuration. In some aspects, circuitry for sending 1320 includes circuitry for sending the second aperiodic CSI report.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1000 described with respect to FIG. 10, or any aspect related to it, including any operations described in relation to FIG. 10; and the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for obtaining 1435. Processing of the code 1430 and 1435 may enable and cause the communications device 1400 to perform the method 1000 described with respect to FIG. 10, or any aspect related to it; and the method 1200 described with respect to FIG. 12, or any aspect related to it.

For example, in some aspects, code for sending 1430 includes code for sending an indication to report CSI. In some aspects, code for obtaining 1435 includes code for obtaining, after the indication to report the CSI, a first CSI report that includes an explicit indication of an association between the first CSI report and a first receiver configuration. In some aspects, code for obtaining 1435 includes code for obtaining a second CSI report that includes an explicit indication of an association between the second CSI report and a second receiver configuration, wherein the first receiver configuration is different from the second receiver configuration.

For example, in some aspects, code for sending 1430 includes code for sending first signaling that includes an indication to report a first aperiodic CSI report and an indication of an association between the first aperiodic CSI report and a first receiver configuration. In some aspects, code for obtaining 1435 includes code for obtaining the first aperiodic CSI report. In some aspects, code for sending 1430 includes code for sending second signaling that includes an indication to report a second aperiodic CSI report and an indication of an association between the second aperiodic CSI report and a second receiver configuration. In some aspects, code for obtaining 1435 includes code for obtaining the second aperiodic CSI report.

The one or more processors 1410 include circuitry configured to implement (e.g., execute) the code stored in the computer-readable medium/memory 1425, including circuitry for sending 1415 and circuitry for obtaining 1420. Processing with circuitry 1415 and 1420 may enable and cause the communications device 1400 to perform the method 1000 described with respect to FIG. 10, or any aspect related to it; and the method 1200 described with respect to FIG. 12, or any aspect related to it.

For example, in some aspects, circuitry for sending 1415 includes circuitry for sending an indication to report CSI. In some aspects, circuitry for obtaining 1420 includes circuitry for obtaining, after the indication to report the CSI, a first CSI report that includes an explicit indication of an association between the first CSI report and a first receiver configuration. In some aspects, circuitry for obtaining 1420 includes circuitry for obtaining a second CSI report that includes an explicit indication of an association between the second CSI report and a second receiver configuration, wherein the first receiver configuration is different from the second receiver configuration.

For example, in some aspects, circuitry for sending 1415 includes circuitry for sending first signaling that includes an indication to report a first aperiodic CSI report and an indication of an association between the first aperiodic CSI report and a first receiver configuration. In some aspects, circuitry for obtaining 1420 includes circuitry for obtaining the first aperiodic CSI report. In some aspects, circuitry for sending 1415 includes circuitry for sending second signaling that includes an indication to report a second aperiodic CSI report and an indication of an association between the second aperiodic CSI report and a second receiver configuration. In some aspects, circuitry for obtaining 1420 includes circuitry for obtaining the second aperiodic CSI report.

Various components of the communications device 1400 may provide means for performing the method 1000 described with respect to FIG. 10, or any aspect related to it; and the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### Example Clauses

Implementation examples are described in the following numbered clauses:
Clause 1: A method for wireless communications by a UE comprising: obtaining an indication to report CSI; sending, after the indication to report the CSI, a first CSI report that includes an explicit indication of an association between the first CSI report and a first receiver configuration; and sending a second CSI report that includes an explicit indication of an association between the second CSI report and a second receiver configuration, wherein the first receiver configuration is different from the second receiver configuration.
Clause 2: The method of Clause 1, wherein the association between the first CSI report and the first receiver configuration indicates at least a portion of the first CSI report is based at least in part on one or more measurements of the first receiver configuration.
Clause 3: The method of any one of Clauses 1-2, further comprising: obtaining first signaling using the first receiver configuration, wherein the first CSI report includes an indication of one or more first measurements of the first signaling; and obtaining second signaling using the second receiver configuration, wherein the second CSI report includes an indication of one or more second measurements of the second signaling.
Clause 4: The method of any one of Clauses 1-3, wherein the first receiver configuration includes a different number of receiver chains than the second receiver configuration.
Clause 5: The method of any one of Clauses 1-4, wherein: obtaining the indication to report the CSI comprises obtaining one or more configurations that indicate to report the CSI with a periodicity; and sending the first CSI report comprises sending the first CSI report according to the one or more configurations.
Clause 6: The method of Clause 5, further comprising sending a third CSI report according to the one or more configurations, wherein the third CSI report includes an explicit indication of an association between the third CSI report and the first receiver configuration.
Clause 7: The method of Clause 5, wherein sending the first CSI report and the second CSI report comprises sending a third CSI report according to the one or more configurations, where the third CSI report includes the first CSI report and the second CSI report.
Clause 8: The method of Clause 5, wherein: the one or more configurations indicate to report CSI via a periodic report that includes the first CSI report and the second CSI report; sending the first CSI report comprises sending, in a first transmission occasion, a first instance of the periodic report that includes the first CSI report without the second CSI report; and sending the second CSI report comprises sending, in a second transmission occasion, a second instance of the periodic report that includes the first CSI report and the second CSI report.
Clause 9: The method of Clause 8, wherein sending the first CSI report comprises sending, in the first transmission occasion, the first instance of the periodic report that includes the first CSI report and information, wherein the information includes substitute information associated with the second CSI report.
Clause 10: The method of Clause 8, further comprising sending an indication that the first CSI report is communicated via a first set of communication resources, and that the second CSI report is communicated via a second set of communication resources.
Clause 11: The method of Clause 8, wherein the one or more configurations indicate the first CSI report is communicated via a first set of communication resources, and that the second CSI report is communicated via a second set of communication resources.
Clause 12: The method of any one of Clauses 1-11, wherein: obtaining the indication to report the CSI comprises obtaining signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period; sending the first CSI report comprises sending the first CSI report after the signaling; and sending the second CSI report comprises sending the second CSI report after the time period.
Clause 13: The method of Clause 12, wherein the signaling further indicates to report the aperiodic CSI based on the first receiver configuration.
Clause 14: The method of any one of Clauses 1-13, further comprising obtaining one or more configurations that indicates a first association between a first aperiodic CSI report and the first receiver configuration, and that indicates a second association between a second aperiodic CSI report and the second receiver configuration, wherein obtaining the indication to report the CSI comprises obtaining signaling that indicates to report the first aperiodic CSI report, and wherein sending the first CSI report comprises sending the first CSI report after the signaling.
Clause 15: A method for wireless communications by a network node comprising: sending an indication to report CSI; obtaining, after the indication to report the CSI, a first CSI report that includes an explicit indication of an association between the first CSI report and a first receiver configuration; and obtaining a second CSI report that includes an explicit indication of an association between the second CSI report and a second receiver configuration, wherein the first receiver configuration is different from the second receiver configuration.
Clause 16: The method of Clause 15, wherein the association between the first CSI report and the first receiver configuration indicates at least a portion of the first CSI report is based at least in part on one or more measurements of the first receiver configuration.
Clause 17: The method of any one of Clauses 15-16, further comprising: sending first signaling, wherein the first CSI report includes an indication of one or more first measurements of the first signaling; and sending second signaling, wherein the second CSI report includes an indication of one or more second measurements of the second signaling.
Clause 18: The method of any one of Clauses 15-17, wherein the first receiver configuration includes a different number of receiver chains than the second receiver configuration.
Clause 19: The method of any one of Clauses 15-18, wherein: sending the indication to report the CSI comprises sending one or more configurations that indicate to report the CSI with a periodicity; and obtaining the first CSI report comprises obtaining the first CSI report according to the one or more configurations.
Clause 20: The method of Clause 19, further comprising obtaining a third CSI report according to the one or more configurations, wherein the third CSI report includes an explicit indication of an association between the third CSI report and the first receiver configuration.
Clause 21: The method of Clause 19, wherein obtaining the first CSI report and the second CSI report comprises obtaining a third CSI report according to the one or more configurations, where the third CSI report includes the first CSI report and the second CSI report.
Clause 22: The method of Clause 19, wherein: the one or more configurations indicate to report CSI via a periodic report that includes the first CSI report and the second CSI report; obtaining the first CSI report comprises obtaining, in a first transmission occasion, a first instance of the periodic report that includes the first CSI report without the second CSI report; and obtaining the second CSI report comprises obtaining, in a second transmission occasion, a second instance of the periodic report that includes the first CSI report and the second CSI report.
Clause 23: The method of Clause 22, wherein obtaining the first CSI report comprises obtaining, in the first transmission occasion, the first instance of the periodic report that includes the first CSI report and information, wherein the information includes substitute information associated with the second CSI report.
Clause 24: The method of Clause 22, further comprising obtaining an indication that the first CSI report is communicated via a first set of communication resources, and that the second CSI report is communicated via a second set of communication resources.
Clause 25: The method of Clause 22, wherein the one or more configurations indicate the first CSI report is communicated via a first set of communication resources, and that the second CSI report is communicated via a second set of communication resources.
Clause 26: The method of any one of Clauses 15-25, wherein: sending the indication to report the CSI comprises sending signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period; obtaining the first CSI report comprises obtaining the first CSI report after the signaling; and obtaining the second CSI report comprises obtaining the second CSI report after the time period.
Clause 27: The method of Clause 26, wherein the signaling further indicates to report the aperiodic CSI based on the first receiver configuration.
Clause 28: The method of any one of Clauses 15-27, further comprising sending one or more configurations that indicates a first association between a first aperiodic CSI report and the first receiver configuration, and that indicates a second association between a second aperiodic CSI report and the second receiver configuration, wherein sending the indication to report the CSI comprises sending signaling that indicates to report the first aperiodic CSI report, wherein obtaining the first CSI report comprises obtaining the first CSI report after the signaling.
Clause 29: A method for wireless communications by a UE comprising: obtaining first signaling that includes an indication to report a first aperiodic CSI report and an indication of an association between the first aperiodic CSI report and a first receiver configuration; sending the first aperiodic CSI report; obtaining second signaling that includes an indication to report a second aperiodic CSI report and an indication of an association between the second aperiodic CSI report and a second receiver configuration; and sending the second aperiodic CSI report.
Clause 30: The method of Clause 29, wherein the association between the first aperiodic CSI report and the first receiver configuration indicates at least a portion of the first aperiodic CSI report is based at least in part on one or more measurements of the first receiver configuration.
Clause 31: The method of any one of Clauses 29-30, further comprising: obtaining third signaling using the first receiver configuration, wherein the first aperiodic CSI report includes an indication of one or more first measurements of the third signaling; and obtaining fourth signaling using the second receiver configuration, wherein the second aperiodic CSI report includes an indication of one or more second measurements of the fourth signaling.
Clause 32: The method of any one of Clauses 29-31, wherein the first receiver configuration includes a different number of receiver chains than the second receiver configuration.
Clause 33: The method of any one of Clauses 29-32, wherein: the first signaling further includes an indication to enable the first receiver configuration for CSI measurement for a time period after the first signaling, and wherein the first signaling further includes an indication to enable the second receiver configuration for CSI measurement after the time period; sending the first aperiodic CSI report comprises sending the first aperiodic CSI report after the first signaling; and sending the second aperiodic CSI report comprises sending the second aperiodic CSI report after the time period.
Clause 34: The method of Clause 33, wherein the first signaling further indicates to report the first aperiodic CSI report based on the first receiver configuration.
Clause 35: The method of any one of Clauses 29-34, further comprising obtaining one or more configurations that includes an explicit indication of an association between the first aperiodic CSI report and the first receiver configuration, and an explicit indication of an association between the second aperiodic CSI report and the second receiver configuration, wherein the indication of the association between the first aperiodic CSI report and the first receiver configuration includes an explicit indication of the association between the first aperiodic CSI report and the first receiver configuration, and wherein sending the first aperiodic CSI report comprises sending the first aperiodic CSI report after the first signaling.
Clause 36: A method for wireless communications by a network node comprising: sending first signaling that includes an indication to report a first aperiodic CSI report and an indication of an association between the first aperiodic CSI report and a first receiver configuration; obtaining the first aperiodic CSI report; sending second signaling that includes an indication to report a second aperiodic CSI report and an indication of an association between the second aperiodic CSI report and a second receiver configuration; and obtaining the second aperiodic CSI report.
Clause 37: The method of Clause 36, wherein the association between the first aperiodic CSI report and the first receiver configuration indicates at least a portion of the first aperiodic CSI report is based at least in part on one or more measurements of the first receiver configuration.
Clause 38: The method of any one of Clauses 36-37, further comprising: sending third signaling, wherein the first aperiodic CSI report includes an indication of one or more first measurements of the third signaling; and sending fourth signaling, wherein the second aperiodic CSI report includes an indication of one or more second measurements of the fourth signaling.
Clause 39: The method of any one of Clauses 36-38, wherein the first receiver configuration includes a different number of receiver chains than the second receiver configuration.
Clause 40: The method of any one of Clauses 36-39, wherein: the first signaling further includes an indication to enable the first receiver configuration for CSI measurement for a time period after the first signaling, and wherein the first signaling further includes an indication to enable the second receiver configuration for CSI measurement after the time period; obtaining the first aperiodic CSI report comprises obtaining the first aperiodic CSI report after the first signaling; and obtaining the second aperiodic CSI report comprises obtaining the second aperiodic CSI report after the time period.
Clause 41: The method of Clause 40, wherein the first signaling further indicates to report the first aperiodic CSI report based on the first receiver configuration.
Clause 42: The method of any one of Clauses 36-41, further comprising sending one or more configurations that includes an explicit indication of an association between the first aperiodic CSI report and the first receiver configuration, and an explicit indication of an association between the second aperiodic CSI report and the second receiver configuration, wherein the indication of the association between the first aperiodic CSI report and the first receiver configuration includes an explicit indication of the association between the first aperiodic CSI report and the first receiver configuration, and wherein obtaining the first aperiodic CSI report comprises obtaining the first aperiodic CSI report after the first signaling.
Clause 43: One or more apparatuses, comprising: one or more memories comprising executable instructions; and one or more processors configured to execute the executable instructions and cause the one or more apparatuses to perform a method in accordance with any one of Clauses 1-42.
Clause 44: One or more apparatuses configured for wireless communications, comprising: one or more memories; and one or more processors, coupled to the one or more memories, configured to cause the one or more apparatuses to perform a method in accordance with any one of Clauses 1-42.
Clause 45: One or more apparatuses configured for wireless communications, comprising: one or more memories; and one or more processors, coupled to the one or more memories, configured to perform a method in accordance with any one of Clauses 1-42.
Clause 46: One or more apparatuses, comprising means for performing a method in accordance with any one of Clauses 1-42.
Clause 47: One or more non-transitory computer-readable media comprising executable instructions that, when executed by one or more processors of one or more apparatuses, cause the one or more apparatuses to perform a method in accordance with any one of Clauses 1-42.
Clause 48: One or more computer program products embodied on one or more computer-readable storage media comprising code for performing a method in accordance with any one of Clauses 1-42.
Clause 49: One or more apparatuses configured for wireless communications, comprising: a processing system that includes one or more processors and one or more memories coupled with the one or more processors, the processing system configured to cause the one or more apparatuses to perform a method in accordance with any one of Clauses 1-42.
Clause 50: A user equipment (UE), comprising: a processing system that includes processor circuitry and memory circuitry that stores code and is coupled with the processor circuitry, the processing system configured to cause the UE to perform a method in accordance with any one of Clauses 1-42.
Clause 51: A network node, comprising: a processing system that includes processor circuitry and memory circuitry that stores code and is coupled with the processor circuitry, the processing system configured to cause the network node to perform a method in accordance with any one of Clauses 1-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications at a user equipment (UE), comprising:
one or more memories; and
one or more processors coupled to the one or more memories and configured to cause the UE to:
obtain an indication to report channel state information (CSI);
send, after the indication to report the CSI, a first CSI report that includes an explicit indication of an association between the first CSI report and a first receiver configuration; and
send a second CSI report that includes an explicit indication of an association between the second CSI report and a second receiver configuration, wherein the first receiver configuration is different from the second receiver configuration.

2. The apparatus of claim 1, wherein the association between the first CSI report and the first receiver configuration indicates at least a portion of the first CSI report is based at least in part on one or more measurements of the first receiver configuration.

3. The apparatus of claim 1, wherein:
the one or more processors are configured to cause the UE to obtain first signaling using the first receiver configuration, wherein the first CSI report includes an indication of one or more first measurements of the first signaling; and
the one or more processors are configured to cause the UE to obtain second signaling using the second receiver configuration, wherein the second CSI report includes an indication of one or more second measurements of the second signaling.

4. The apparatus of claim 1, wherein the first receiver configuration includes a different number of receiver chains than the second receiver configuration.

5. The apparatus of claim 1, wherein:
to cause the UE to obtain the indication to report the CSI, the one or more processors are configured to cause the UE to obtain one or more configurations that indicate to report the CSI with a periodicity; and
to cause the UE to send the first CSI report, the one or more processors are configured to cause the UE to send the first CSI report according to the one or more configurations.

6. The apparatus of claim 5, wherein the one or more processors are configured to cause the UE to send a third CSI report according to the one or more configurations, wherein the third CSI report includes an explicit indication of an association between the third CSI report and the first receiver configuration.

7. The apparatus of claim 5, wherein to cause the UE to send the first CSI report and the second CSI report, the one or more processors are configured to cause the UE to send a third CSI report according to the one or more configurations, where the third CSI report includes the first CSI report and the second CSI report.

8. The apparatus of claim 5, wherein:
the one or more configurations indicate to report CSI via a periodic report that includes the first CSI report and the second CSI report;
to cause the UE to send the first CSI report, the one or more processors are configured to cause the UE to send, in a first transmission occasion, a first instance of the periodic report that includes the first CSI report without the second CSI report; and
to cause the UE to send the second CSI report, the one or more processors are configured to cause the UE to send, in a second transmission occasion, a second instance of the periodic report that includes the first CSI report and the second CSI report.

9. The apparatus of claim 8, wherein to cause the UE to send the first CSI report, the one or more processors are configured to cause the UE to send, in the first transmission occasion, the first instance of the periodic report that includes the first CSI report and information, wherein the information includes substitute information associated with the second CSI report.

10. The apparatus of claim 8, wherein the one or more processors are configured to cause the UE to send an indication that the first CSI report is communicated via a first set of communication resources, and that the second CSI report is communicated via a second set of communication resources.

11. The apparatus of claim 8, wherein the one or more configurations indicate the first CSI report is communicated via a first set of communication resources, and that the second CSI report is communicated via a second set of communication resources.

12. The apparatus of claim 1, wherein:
to cause the UE to obtain the indication to report the CSI, the one or more processors are configured to cause the UE to obtain signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period;
to cause the UE to send the first CSI report, the one or more processors are configured to cause the UE to send the first CSI report after the signaling; and
to cause the UE to send the second CSI report, the one or more processors are configured to cause the UE to send the second CSI report after the time period.

13. The apparatus of claim 12, wherein the signaling further indicates to report the aperiodic CSI based on the first receiver configuration.

14. The apparatus of claim 1, wherein:
the one or more processors are configured to cause the UE to obtain one or more configurations that indicates a first association between a first aperiodic CSI report and the first receiver configuration, and that indicates a second association between a second aperiodic CSI report and the second receiver configuration;
to cause the UE to obtain the indication to report the CSI, the one or more processors are configured to cause the UE to obtain signaling that indicates to report the first aperiodic CSI report; and
to cause the UE to send the first CSI report, the one or more processors are configured to cause the UE to send the first CSI report after the signaling.

15. An apparatus configured for wireless communications at a network node, comprising:
one or more memories; and
one or more processors coupled to the one or more memories and configured to cause the network node to:
send an indication to report channel state information (CSI);
obtain, after the indication to report the CSI, a first CSI report that includes an explicit indication of an association between the first CSI report and a first receiver configuration; and
obtain a second CSI report that includes an explicit indication of an association between the second CSI report and a second receiver configuration, wherein the first receiver configuration is different from the second receiver configuration.

16. The apparatus of claim 15, wherein:
to cause the network node to send the indication to report the CSI, the one or more processors are configured to cause the network node to send one or more configurations that indicate to report the CSI with a periodicity; and
to cause the network node to obtain the first CSI report, the one or more processors are configured to cause the network node to obtain the first CSI report according to the one or more configurations.

17. The apparatus of claim 16, wherein the one or more processors are configured to cause the network node to obtain a third CSI report according to the one or more configurations, wherein the third CSI report includes an explicit indication of an association between the third CSI report and the first receiver configuration.

18. The apparatus of claim 16, wherein to cause the network node to obtain the first CSI report and the second CSI report, the one or more processors are configured to cause the network node to obtain a third CSI report according to the one or more configurations, where the third CSI report includes the first CSI report and the second CSI report.
second CSI report is communicated via a second set of communication resources.

19. The apparatus of claim 15, wherein:
to cause the network node to send the indication to report the CSI, the one or more processors are configured to cause the network node to send signaling that indicates to report aperiodic CSI, wherein the signaling further indicates to enable the first receiver configuration for CSI measurement for a time period after the signaling, and wherein the signaling further indicates to enable the second receiver configuration for CSI measurement after the time period;
to cause the network node to obtain the first CSI report, the one or more processors are configured to cause the network node to obtain the first CSI report after the signaling; and
to cause the network node to obtain the second CSI report, the one or more processors are configured to cause the network node to obtain the second CSI report after the time period.

20. A method for wireless communications at a user equipment (UE), comprising:
obtaining an indication to report channel state information (CSI);
sending, after the indication to report the CSI, a first CSI report that includes an explicit indication of an association between the first CSI report and a first receiver configuration; and
sending a second CSI report that includes an explicit indication of an association between the second CSI report and a second receiver configuration, wherein the first receiver configuration is different from the second receiver configuration.
